(19) United States
(12) Patent Application Publication
(10) Pub. No.: US 2023/0164648 A1
(43) Pub. Date: May 25, 2023

(54) METHOD, USER EQUIPMENT AND BASE STATION FOR LINK FAILURE REPORTING

(71) Applicant: Samsung Electronics Co., Ltd., Gyeonggi-do (KR)

(72) Inventors: Weiwei WANG, Beijing (CN); Hong WANG, Beijing (CN); Lixiang XU, Beijing (CN)

(21) Appl. No.: 17/919,877

(22) PCT Filed: Jan. 26, 2021
(86) PCT No.: PCT/KR2021/001027

§ 371 Date: Oct. 19, 2022

(30) Foreign Application Priority Data
Apr. 20, 2020 (CN) 202010313589.6

(51) Int. Cl. H04W 36/00; H04W 36/30

(52) U.S. Cl. CPC H04W 36/0072; H04W 36/305

(57) ABSTRACT

The disclosure provides a method, a terminal and a base station for link failure reporting. The method for link failure reporting comprises: transmitting, to a first base station (B S), a first link failure report message indicating that the UE stores information related to link failure reporting; in response to transmitting the first link failure report message, receiving, from the first BS, a first information request message including a request for the information related to the link failure reporting; and in response to receiving the first information request message, transmitting, to the first BS, first information including the information related to the link failure reporting, wherein the information related to the link failure reporting includes at least one of first link failure information, second link failure information, or information of time length.

### TECHNICAL FIELD

The present disclosure relates to the technical field of wireless communication, and in particular to a method, a terminal and a base station for link failure reporting.

### BACKGROUND ART

In order to meet the increasing demand for wireless data communication services since the deployment of 4G communication systems, efforts have been made to develop improved 5G or pre-5G communication systems. Therefore, the 5G or pre-5G communication systems are also called “beyond 4G networks” or “post-LTE systems”.

Wireless communication is one of the most successful innovations in modern history. Recently, a number of subscribers of wireless communication services have exceeded 5 billion, and it continues growing rapidly. With the increasing popularity of smart phones and other mobile data devices (such as tablet computers, notebook computers, netbooks, e-book readers and machine-type devices) in consumers and enterprises, the demand for wireless data services is growing rapidly. In order to meet the rapid growth of mobile data services and support new applications and deployments, it is very important to improve efficiency and coverage of wireless interfaces.

### DISCLOSURE OF INVENTION

### Technical Problem

A method, a terminal and a base station for link failure reporting is needed.

### Solution to Problem

According to an aspect of the present disclosure, there is provided a method for link failure reporting performed by a user equipment (UE), comprising: transmitting, to a first base station (BS), a first link failure report message indicating that the UE stores information related to link failure reporting; in response to transmitting the first link failure report message, receiving, from the first BS, a first information request message including a request for the information related to the link failure reporting; and in response to receiving the first information request message, transmitting, to the first BS, first information including the information related to the link failure reporting, wherein the information related to the link failure reporting includes at least one of first link failure information, second link failure information, or information of time length.

According to another aspect of the present disclosure, there is provided a method for link failure reporting performed by a first base station (BS), comprising: receiving, from a user equipment (UE), a first link failure report message indicating that the UE stores information related to link failure reporting; in response to receiving the first link failure report message, transmitting, to the UE, a first information request message including a request for the information related to the link failure reporting; and in response to transmitting the first information request message, receiving, from the UE, first information including the information related to the link failure reporting, wherein the information related to the link failure reporting includes at least one of first link failure information, second link failure information, or information of time length

According to another aspect of the present disclosure, there is provided a forwarding method for link failure information performed by a second base station (BS), comprising: receiving, from a first BS, a first failure indication message including information related to the link failure reporting of a user equipment (UE) or information related to reestablishment; and transmitting, to a third BS, a first handover report message including the information related to the link failure reporting of the UE or the information related to the reestablishment.

According to another aspect of the present disclosure, there is provided a user equipment (UE), comprising: a transceiver; and a processor coupled to the transceiver, wherein the processor is configured to be operated according to one of the methods performed by the user equipment.

According to another aspect of the present disclosure, there is provided a base station, comprising: a transceiver; and a processor coupled to the transceiver, wherein the processor is configured to be operated according to one of the methods performed by the above first base station or the second base station.

According to another aspect of the present disclosure, there is provided a non-transitory computer-readable recording medium having stored thereon a program, which when executed by a computer, performs any one of the methods described above.

### Advantageous Effects of Invention

The invention provides a method, a terminal and a base station for link failure reporting, which help solve problems caused by a link failure during a handover.

### BRIEF DESCRIPTION OF DRAWINGS

FIG. 1 is an exemplary system architecture of system architecture evolution (SAE).

FIG. 2 is an exemplary system architecture according to various embodiments of the present disclosure.

FIG. 3 illustrates a schematic diagram of a communication process between a user equipment and a network side in during a handover provided by an embodiment of the present invention.

FIG. 4 illustrates a schematic diagram of cases of link failures provided by an embodiment of the present invention.

FIG. 5 illustrates a flowchart of a method for recording a link failure related information provided by an embodiment of the present disclosure.

FIG. 6 illustrates a flowchart of a configuration method for a link failure provided by an embodiment of the present disclosure.

FIG. 7 illustrates an interactive schematic diagram of a configuration method for a link failure provided by an embodiment of the present disclosure.

FIG. 8 illustrates an interactive schematic diagram of a configuration method for a link failure provided by an embodiment of the present disclosure.

FIG. 9 illustrates a flow chart of a method for link failure reporting provided by an embodiment of the present disclosure.

FIG. 10 illustrates an interactive schematic diagram of a method for link failure reporting provided by an embodiment of the present disclosure.

FIG. 11 illustrates a flow chart of a method for link failure reporting provided by an embodiment of the present disclosure.

FIG. 12 illustrates an interactive schematic diagram of a method for link failure reporting provided by an embodiment of the present disclosure.

FIG. 13 illustrates a part of a flow chart of a method for link failure reporting provided by an embodiment of the present disclosure.

FIG. 14 illustrates a part of a flow chart of a method for link failure reporting provided by an embodiment of the present disclosure.

FIG. 15 illustrates a flow chart of a method for link failure reporting provided by an embodiment of the present disclosure.

FIG. 16 illustrates a flowchart of a forwarding method for link failure information provided by an embodiment of the present disclosure.

FIG. 17 illustrates a schematic diagram of interaction between a first base station and a second base station in a forwarding method for link failure information provided by an embodiment of the present disclosure.

FIG. 18 illustrates a schematic diagram of interaction between a second base station and a third base station in a forwarding method for link failure information provided by an embodiment of the present disclosure.

FIG. 19 illustrates a flow chart of a method for link failure reporting provided by an embodiment of the present disclosure.

FIG. 20 illustrates an interactive schematic diagram of a method for link failure reporting provided by an embodiment of the present disclosure.

FIG. 21 illustrates a timing chart of a method for link failure reporting provided by an embodiment of the present disclosure.

FIG. 22 is a block diagram illustrating a structure of a user equipment according to an embodiment of the present disclosure.

FIG. 23 is a block diagram illustrating a structure of a base station according to an embodiment of the present disclosure

### MODE FOR THE INVENTION

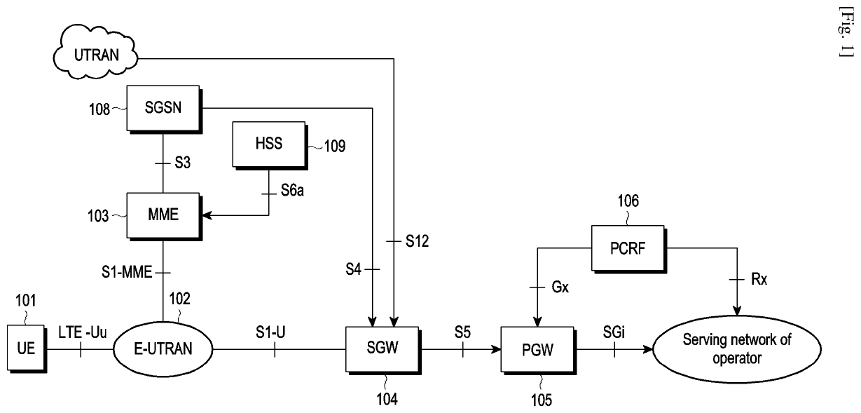

FIGS. 1 to 23 discussed below and various embodiments for describing principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 is an exemplary system architecture 100 of system architecture evolution (SAE). A user equipment (UE) 101 is a terminal device for receiving data. An evolved universal terrestrial radio access network (E-UTRAN) 102 is a radio access network, which includes a macro base station (eNodeB/NodeB) that provides the UE with access to a radio network interface. A mobility management entity (MME) 103 is responsible for managing mobility context, session context and security information of the UE. A serving gateway (SGW) 104 mainly provides functions of a user plane, and MME 103 and the SGW 104 may be in a same physical entity. A packet data network gateway (PGW) 105 is responsible for charging, lawful interception and other functions, and may be in the same physical entity as the SGW 104. A policy and charging rules functional entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including current location of the user equipment, an address of a serving node, user security information, and packet data context of the user equipment.

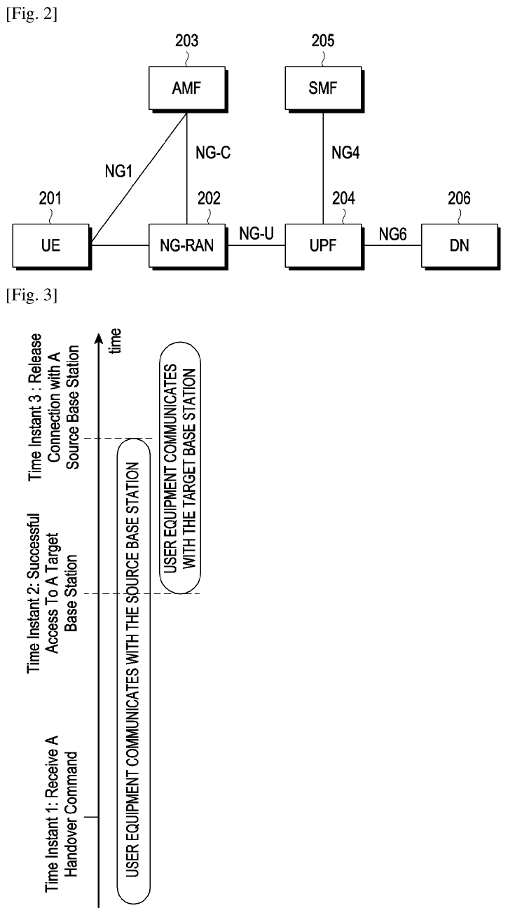

FIG. 2 is an exemplary system architecture 200 according to various embodiments of the present disclosure. Other embodiments of the system architecture 200 can be used without departing from the scope of this disclosure.

A user equipment (UE) 201 is a terminal device for receiving data. A next generation radio access network (NG-RAN) 202 is a radio access network, which includes a base station (gNB or an eNB connected to 5GC of a 5G core network, and the eNB connected to the 5GC is also called ng-gNB) that provides the UE with access to a radio network interface. An access control and mobility management functional entity (AMF) 203 is responsible for managing mobility context and security information of the UE. A user plane function entity (UPF) 204 mainly provides functions of a user plane. A session management functional entity (SMF) 205 is responsible for session management. A data network (DN) 206 includes services of operators, Internet access and services of third parties, and the like.

Exemplary embodiments of the present disclosure are further described below with reference to accompanying drawings.

The text and drawings are provided as examples only to help understand the present disclosure. They should not be interpreted as limiting the scope of this disclosure in any way. Although certain embodiments and examples have been provided, based on the disclosure herein, it will be apparent to those skilled in the art that changes may be made to the illustrated embodiments and examples without departing from the scope of the disclosure.

During a traditional handover, after receiving a handover command, the user equipment first disconnects communication with a source base station, and then starts a process of accessing a target base station. Therefore, the traditional handover mechanism leads to a communication interruption between the user equipment and a network side during the handover.

With the development of technology, a new handover mechanism appears, in which the user equipment maintains a connection with the source base station during the handover. Specifically, after receiving the handover command from the network side, the user equipment maintains the communication with the source base station and starts to establish a connection with the target base station (e.g., starts a random access procedure) at the same time. After establishing the connection with the target base station, the user equipment still maintains the communication with the source base station until the user equipment receives an instruction to release the connection with the source base station.

As an implementation, the handover mechanism may be, for example, a Dual Active Protocol stack (DAPS) handover. A specific implementation of the handover mechanism is not limited by embodiments of the present invention, and may also be other types of handover, such as, a make before break handover, a conditional handover, etc. For convenience of description, the DAPS handover is taken as an example in following description of the present invention.

When the user equipment adopts this DAPS handover mechanism for the handover, a link failure may still occur, but a link reporting method suitable for the traditional handover mechanism is not suitable for this handover mechanism. Therefore, a method for link failure reporting is needed to adapt to this handover mechanism.

Specifically, taking FIG. 3 as an example, the handover mechanism will be explained as below. Referring to FIG. 3, FIG. 3 illustrates a schematic diagram of a communication process between a user equipment and a network side during a handover provided by an embodiment of the present invention.

As shown in FIG. 3, at time instant 1, the user equipment receives a handover command transmitted by a source base station.

As an implementation, the handover command may be a DAPS handover command. Of course, an implementation of the handover command is not limited to this, for example, it may also be a handover command in a make before break handover, a handover command in a conditional handover, and so on.

Specifically, the handover command may be, for example, an RRCReconfiguration message including reconfigurationWithSync information in the TS38.331 standard; for example, it may also be an RRCConnectionReconfiguration message including mobile control information in the TS36.331 standard.

As an implementation, the handover command may include indication information indicating the user equipment to perform a handover. Further, the handover command may be directed to the user equipment or directed to one or more radio bearers of the user equipment. If the handover command is directed to the one or more radio bearers of the user equipment, it means that only these radio bearers maintain a communication with the source base station and a target base station at the same time during the handover.

As a specific example, the handover command is a DAPS handover command, and the DAPS handover command includes indication information indicating the user equipment to perform a DAPS handover. The indication information indicating the user equipment to perform the DAPS handover may be directed to the user equipment or directed to one or more radio bearers of the user equipment.

Please continue to refer to FIG. 3, at time instant 2, the user equipment successfully accesses the target base station.

As an implementation, if the user equipment successfully completes a random access procedure in the target cell or has transmitted an RRCReconfigurationComplete message to the target base station, the user equipment successfully accesses the target base station.

Then, at time instant 3, the network side informs the user to release the connection with the source base station.

As an implementation, the network side may be, for example, the target base station.

As shown in FIG. 3, in this handover mechanism, the user equipment may maintain the communication with the source base station until the time instant 3. Specifically, before the time instant 3, the user equipment may receive downlink data from the source base station, that is, information from the source base station to the user equipment, for example, downlink control information (such as PDCCH, etc.) or downlink data information (such as PDSCH, etc.); or the user equipment may transmit uplink data to the source base station, that is, information from the user equipment to the source base station, for example, uplink control information (such as PUCCH, etc.) or uplink data information (such as PUSCH, etc.); or the user equipment may receive the downlink data from the source base station and transmit the uplink data to the source base station.

Meanwhile, from the time instant 2, the user equipment may communicate with the target base station. Specifically, from the time instant 2, the user equipment may receive downlink data from the target base station, that is, data from the target base station to the user equipment, for example, downlink control information (such as PDCCH, etc.) or downlink data information (such as PDSCH, etc.); or the user equipment may transmit to the target base station uplink data, data from the user equipment to the target base station, for example, uplink control information (such as PUCCH, etc.) or uplink data information (such as PUSCH, etc.); or the user equipment may receive the downlink data from the target base station and transmit the uplink data to the target base station.

Further, the above uplink data may be all of the uplink data or a part of the uplink data; the above downlink data may be all of the downlink data or a part of the downlink data. The above uplink data or downlink data may be data packets or signals.

In a traditional handover process, after receiving the handover command, the user first disconnects the communication with the source base station, and then starts a process of accessing the target base station. Therefore, the traditional handover mechanism leads to communication interruption between the user and the network side during the handover. But this handover mechanism may effectively avoid interruption of data communication between the user and the network side during the handover.

Under this handover mechanism, the user equipment also encounters cases of link failures. For example, the user equipment may have one or more of following link failures:

(1) a source link failure: that is, a link failure occurs in a link between the user equipment and the source base station, for example, a radio link failure;

(2) a target link failure: that is, a link failure occurs in a link between the user equipment and the target base station, for example, a radio link failure;

(3) a handover failure: the user equipment occurs a failure during a process of accessing the target base station. As an example, when in the DAPS handover mechanism, it may also be called a DAPS handover failure.

It can be understood that naming of the link failures described above is only an example of the naming, and other naming manners also belong to the protection scope of this disclosure. As an example, subsequent explanations of this disclosure will use the naming of the link failures described above to distinguish different link failures.

Furthermore, based on the above handover mechanism, one or more of the above link failures may occur, and each link failure may occur at different times during the handover.

Taking FIG. 4 as an example, possible cases of link failures in this handover mechanism will be explained below. However, it can be understood that the possible cases of the link failures in the above handover mechanism are not limited to those shown in FIG. 4, and other cases of the link failures also belong to the protection scope of this disclosure.

Referring to FIG. 4, FIG. 4 illustrates a schematic diagram of cases of link failures in the above handover mechanism provided by an embodiment of the present invention.

As shown in FIG. 4, the cases of the link failures occurred during a handover may be classified into nine cases, and each case will be specifically described as below.

Case 1: the user equipment only encounters a source link failure, and the source link failure occurs before the user equipment successfully accesses a target base station;

Case 2: the user equipment only encounters a handover failure, for example, a DAPS handover failure;

Case 3: the user equipment only encounters the source link failure, and the source link failure occurs after the user equipment successfully accesses the target base station;

Case 4: the user equipment only encounters a target link failure, and the target link failure occurs after the user equipment successfully accesses the target base station;

Case 5: the user equipment first encounters the source link failure, and then encounters the handover failure, for example, the DAPS handover failure;

Case 6: the user equipment first encounters the handover failure(for example, the DAPS handover failure), and then encounters the source link failure;

Case 7: the user equipment first encounters the source link failure, and then after the successfully accessing to the target base station, the user equipment encounters the target link failure;

Case 8: after successfully accessing to the target base station, the user equipment first encounters the source link failure and then encounters the target link failure;

Case 9: after successfully accessing to the target base station, the user equipment first encounters the target link failure and then encounters the source link failure.

The above-mentioned link failures may be caused by unreasonable parameter setting of the handover mechanism, but a traditional link failure reporting mechanism is not suitable for the above-mentioned handover mechanism, and it may not help a network side to find out problems of parameter configuration in the above-mentioned handover by using information reported in the traditional link failure reporting mechanism. Therefore, the present disclosure intends to provide a link failure reporting mechanism to help the network side solve problems encountered during the handover.

First, several kinds of information to be used in embodiments of the present invention will be described below.

1. First Link Failure Information

The first link failure information may include at least one of the following information.

(1) measurement information of a cell obtained by a user equipment when a first link failure occurs;

Herein, the cell may be, for example, a 5G cell or an LTE cell, which is not limited by the present disclosure.

As an implementation, the cell may include, for example, one or more of followings.
a serving cell where the user equipment is located when the first link failure occurs;
one or more neighbor cells of the serving cell where the user equipment is located when the first link failure occurs;
a source cell where the user equipment is located when performing a handover (for example, a DAPS handover, etc.);
one or more neighbor cells of the source cell where the user equipment is located when performing the handover (for example, the DAPS handover, etc.);
a target cell of the user equipment when performing the handover (for example, the DAPS handover, etc.);
one or more neighbor cells of the target cell of the user equipment when performing the handover (for example, the DAPS handover, etc.).

As an implementation, the measurement information of the cell obtained by the user equipment may, for example include one or more of followings.
RSRP (Reference Signal Receiving Power), and/or RSRQ (Reference Signal Receiving Quality) and/or SINR (Signal to Interference plus Noise Ratio) of the cell;
measurement results of the cell obtained based on a SSB (Synchronization Signal Block) measurement, and the measurement results may be, for example, the RSRP, and/or the RSRQ, and/or the SINR;
measurement results of the cell obtained based on a CSI-RS measurement, and the measurement results may be, for example the RSRP, and/or the RSRQ, and/or the SINR;
measurement information of each SSB, herein, each SSB measurement information includes index information of the SSB and measurement results of the SSB corresponding to the index information of the SSB, herein, the measurement results of the SSB may be, for example, the RSRP, and/or the RSRQ, and/or the SINR;
measurement information of each CSI-RS, herein, the measurement information of each CSI-RS includes index information of the CSI-RS and measurement results of the CSI-RS corresponding to the index information of the CSI-RS, and the measurement results of the CSI-RS may be, for example, the RSRP, and/or the RSRQ, and/or the SINR.

It can be understood that the above-mentioned implementation is only shown as an example, and is not a limitation of the present disclosure, and respective implementation may be used alone or in combination. For example, the measurement information of the cell obtained by the user equipment when the first link failure occurs may be the RSRP, and/or the RSRQ, and/or the SINR of the serving cell where the user equipment is located when the first link failure occurs; or the RSRP, and/or the RSRQ, and/or the SINR of the serving cell where the user equipment is located when the first link failure occurs, which is obtained based on the SSB measurement; it may also be the RSRP, and/or the RSRQ, and/or the SINR of the source cell where the user equipment is located when performing the handover (for example, the DAPS handover, etc.), which is obtained based on the CSI-RS measurement, and the like, and any combination way belongs to the protection scope of this disclosure.

(2) first identification information of the user equipment;

The identification information of the user equipment may be, for example, a Cell-Radio Network Temporary Identifier (C-RNTI) or other information for identifying the user equipment. As an implementation, the first identification information may be the identification information of the user equipment when the first link failure occurs, and the identification information may include, for example, at least one of following information.
identification information in the serving cell (or PCell) where the user equipment is located when the first link failure occurs;
identification information in a source cell (or source PCell) where the user equipment is located when the first link failure occurs;
identification information of the user equipment in the source cell (or the source PCell), for example, the C-RNTI, which indicates the identification information of the user equipment in the source cell (or the source PCell) when the user equipment performs the handover (for example, the DAPS handover, etc.);
identification information of the user equipment in the target cell (or target PCell), such as the C-RNTI, which indicates the identification information of the user equipment in the target cell (or the target PCell) when the user equipment performs the handover (for example, the DAPS handover, etc.);

(3) identification information of a cell where the user equipment is located when a handover command is received before the first link failure (Previous Cell/PCell ID);

The identification information may be, for example, one or more of NR (new radio) CGI (Global Cell Identifier), PCI (Physical Cell Identifier), carrier frequency, etc.

As an implementation, the identification information may include, for example, at least one of following information.
identification information of the cell (or a source cell) where the user equipment is located when the handover command is received before the first link failure, for example, one or more of the NR CGI, the PCI, the carrier frequency, etc. of the cell (or a source cell) where the user equipment is located when the handover command is received before the first link failure;
identification information of the source cell of the handover (e.g., the DAPS handover, etc.), e.g., one or more of NR CGI, PCI, carrier frequency, etc. of the source cell of the handover (e.g., the DAPS handover, etc.);
identification information of the cell where the user equipment is located when the handover (for example, the DAPS handover, etc.) command is received, for example, one or more of the NR CGI, the PCI, the carrier frequency, etc. of the cell where the user equipment is located when the handover (for example, the DAPS handover, etc.) command is received.

(4) indication information of the cell where the user equipment is located when the first link failure occurs;

As an implementation, the indication information may indicate, for example, at least one of following information.
The first link failure occurs in the source cell of the handover (e.g., the DAPS handover, etc.);
The first link failure occurs in the target cell of handover e.g., the DAPS handover, etc.).

(5) identification information of the cell where the user equipment is located when the first link failure occurs (failedPCellID);

The identification information may be, for example, one or more of the NR CGI, the PCI, the carrier frequency, etc.

As an implementation, the identification information may include, for example, at least one of following information.
identification information of the cell or PCell where the user equipment is located when the user equipment detects the first link failure, for example, one or more of the NR CGI, the PCI, the carrier frequency, etc. of the cell or PCell where the user equipment is located when the user equipment detects the first link failure;
identification information of the target cell or the target PCell when the user equipment encounters a handover failure (or a DAPS handover failure), for example, one or more of the NR CGI, the PCI and the carrier frequency of the target cell or the target PCell when the user equipment occurs the handover failure (or the DAPS handover failure);
identification information of the source cell or the PCell of the handover (e.g., the DAPS handover, etc.), for example, one or more of the NR CGI, the PCI, the carrier frequency, etc. of the source cell or the PCell of the handover (e.g., the DAPS handover, etc.);
identification information of the target cell or the PCell of the handover (e.g., the DAPS handover, etc.), e.g., one or more of the NR CGI, the PCI, the carrier frequency, etc. of the target cell or the PCell of the handover (e.g., the DAPS handover, etc.).

(6) indication information of occurrence time of the first link failure;

As an implementation, the indication information may indicate, for example, at least one of the following.
The first link failure occurs before successful access to one cell.

The cell successfully accessed may be, for example, the target cell of the handover (for example, the DAPS handover, etc.), herein, the successful access to one cell may refer to the fact that, for example, a random access procedure in the cell is successfully completed, or an RRCReconfigurationComplete message is transmitted to the cell.

As an implementation, the indication information may indicate, for example, that the source link failure occurs before successful access to the target cell of the DAPS.
The first link failure occurs after successful access to one cell.

The cell successfully accessed may be, for example, the target cell of the handover (for example, the DAPS handover, etc.), herein, the successful access to one cell may refer to the fact that, for example, a random access procedure in the cell is successfully completed, or an RRCReconfigurationComplete message is transmitted to the cell.

As an implementation, the indication information may indicate, for example, that the source link failure occurs after successful access to the target cell of the DAPS.
The first link failure occurs after the second link failure.

As an implementation, the indication information may indicate that the source link failure occurs after the target link failure, for example.

As another implementation, the indication information may indicate that the target link failure occurs after the source link failure, for example.
The second link failure occurs before the first link failure.

As an implementation, the indication information may indicate that the source link failure occurs before the target link failure, for example.

As another implementation, the indication information may indicate that the target link failure occurs before the source link failure, for example.

(7) indication information of a type of the first link failure;

As an implementation, the indication information may indicate at least one of followings, for example.
a radio link failure;
a handover failure (for example, a DAPS handover failure, etc.);
a source link failure, i.e., indicate that the first link failure is a radio link failure that occurs in the source cell of the handover (e.g., the DAPS handover failure, etc.);
a target link failure, i.e., indicate that the first link failure is a radio link failure that occurs in the target cell of the handover (e.g., the DAPS handover failure, etc.).

(8) cause information of the first link failure;

As an implementation, the cause information of the first link failure may, for example, include at least one of followings.
timer timeout, for example, t310 timeout, etc.;
a random access failure;
reaching a maximum number of retransmission of a RLC layer;
a beam failure recovery failure.

(9) identification information of the target cell of the handover;

Herein, the identification information may be, for example, the NR CGI, and/or the PCI, and/or the carrier frequency, etc.

As an implementation, the target cell is a target cell of the DAPS handover, and the identification information of the target cell is the NR CGI, and/or the PCI, and/or the carrier frequency, etc. of the target cell of the DAPS handover.

(10) indication information of a type of the handover.

The type of the handover that the indication information may indicate includes, for example, a non-DAPS handover, a DAPS handover, and a traditional/normal handover, etc.

Of course, it can be understood that the indication information may also include, for example, a make before break handover, a non-make before break handover, a conditional handover, a non-conditional handover, etc. The present invention is not limited to this.

2. Second Link Failure Information

The second link failure information may include at least one of following information.

(1) measurement information of a cell obtained by a user equipment when a second link failure occurs;

Herein, the cell may be, for example, a 5G cell or a LTE cell, which is not limited by this disclosure.

As an implementation, the cell may include, for example, one or more of followings.
a serving cell where the user equipment is located when the second link failure occurs;
one or more neighbor cells of the serving cell where the user equipment is located when the second link failure occurs;
a source cell where the user equipment is located when performing a handover (for example, a DAPS handover, etc.);
one or more neighbor cells of the source cell where the user equipment is located when performing the handover (for example, the DAPS handover, etc.);
a target cell of the user equipment when performing the handover (for example, the DAPS handover, etc.);
one or more neighbor cells of the target cell of the user equipment when performing the handover (for example, the DAPS handover, etc.).

As an implementation, the measurement information of the cell obtained by the user equipment may, for example include one or more of followings.
RSRP (Reference Signal Receiving Power), and/or RSRQ (Reference Signal Receiving Quality) and/or SINR (Signal to Interference plus Noise Ratio) of the cell;
measurement results of the cell obtained based on a SSB (Synchronization Signal Block) measurement, and the measurement results may be, for example, the RSRP, and/or the RSRQ, and/or the SINR;
measurement results of the cell obtained based on a CSI-RS measurement, and the measurement results may be, for example the RSRP, and/or the RSRQ, and/or the SINR;
measurement information of each SSB, herein, each SSB measurement information includes index information of the SSB and measurement results of the SSB corresponding to the index information of the SSB, herein, the measurement results of the SSB may be, for example, the RSRP, and/or the RSRQ, and/or the SINR;
measurement information of each CSI-RS, herein, the measurement information of each CSI-RS includes index information of the CSI-RS and measurement results of the CSI-RS corresponding to the index information of the CSI-RS, and the measurement results of the CSI-RS may be, for example, the RSRP, and/or the RSRQ, and/or the SINR.

It can be understood that the above-mentioned implementation is only shown as an example, and is not a limitation of the present disclosure, and respective implementation may be used alone or in combination. For example, the measurement information of the cell obtained by the user equipment when the second link failure occurs may be the RSRP, and/or the RSRQ, and/or the SINR of the serving cell where the user equipment is located when the second link failure occurs; or the RSRP, and/or the RSRQ, and/or the SINR of the serving cell where the user equipment is located when the second link failure occurs, which is obtained based on the SSB measurement; it may also be the RSRP, and/or the RSRQ, and/or the SINR of the source cell where the user equipment is located when performing the handover (for example, the DAPS handover, etc.), which is obtained based on the CSI-RS measurement, and the like, and any combination way belongs to the protection scope of this disclosure.

(2) second identification information of the user equipment;

The identification information of the user equipment may be, for example, a Cell-Radio Network Temporary Identifier (C-RNTI) or other information for identifying the user equipment. As an implementation, the second identification information may be the identification information of the user equipment when the second link failure occurs, and the identification information may include, for example, at least one of following information.
identification information in the serving cell (or PCell) where the user equipment is located when the second link failure occurs;
identification information in a source cell (or source PCell) where the user equipment is located when the second link failure occurs;
identification information of the user equipment in the source cell (or the source PCell), for example, the C-RNTI, which indicates the identification information of the user equipment in the source cell (or the source PCell) when the user equipment performs the handover (for example, the DAPS handover, etc.);
identification information of the user equipment in the target cell (or target PCell), such as the C-RNTI, which indicates the identification information of the user equipment in the target cell (or the target PCell) when the user equipment performs the handover (for example, the DAPS handover, etc.).

(3) identification information of a cell where the user equipment is located when a handover command is received before the second link failure (Previous Cell/PCell ID);

The identification information may be, for example, one or more of NR (new radio) CGI (Global Cell Identifier), PCI (Physical Cell Identifier), carrier frequency, etc.

As an implementation, the identification information may include, for example, at least one of following information.
identification information of the cell (or a source cell) where the user equipment is located when the handover command is received before the second link failure, for example, one or more of the NR CGI, the PCI, the carrier frequency, etc. of the cell (or a source cell) where the user equipment is located when the handover command is received before the second link failure;
identification information of the source cell of the handover (e.g., the DAPS handover, etc.), e.g., one or more of NR CGI, PCI, carrier frequency, etc. of the source cell of the handover (e.g., the DAPS handover, etc.);
identification information of the cell where the user equipment is located when the handover (for example, the DAPS handover, etc.) command is received, for example, one or more of the NR CGI, the PCI, the carrier frequency, etc. of the cell where the user equipment is located when the handover (for example, the DAPS handover, etc.) command is received.

(4) indication information of the cell where the user equipment is located when the second link failure occurs;

As an implementation, the indication information may indicate, for example, at least one of following information.
The second link failure occurs in the source cell of the handover (e.g., the DAPS handover, etc.);
The second link failure occurs in the target cell of handover (e.g., the DAPS handover, etc.).

(5) identification information of the cell where the user equipment is located when the second link failure occurs (failedPCellID);

The identification information may be, for example, one or more of the NR CGI, the PCI, the carrier frequency, etc.

As an implementation, the identification information may include, for example, at least one of following information.
identification information of the cell or PCell where the user equipment is located when the user equipment detects the second link failure, for example, one or more of the NR CGI, the PCI, the carrier frequency, etc. of the cell or PCell where the user equipment is located when the user equipment detects the second link failure;
identification information of the target cell or the target PCell when the user equipment encounters a handover failure (or a DAPS handover failure), for example, one or more of the NR CGI, the PCI and the carrier frequency of the target cell or the target PCell when the user equipment occurs the handover failure (or the DAPS handover failure);
identification information of the source cell or the PCell of the handover (e.g., the DAPS handover, etc.), for example, one or more of the NR CGI, the PCI, the carrier frequency, etc. of the source cell or the PCell of the handover (e.g., the DAPS handover, etc.);
identification information of the target cell or the PCell of the handover (e.g., the DAPS handover, etc.), e.g., one or more of the NR CGI, the PCI, the carrier frequency, etc. of the target cell or the PCell of the handover (e.g., the DAPS handover, etc.).

(6) indication information of occurrence time of the second link failure;

As an implementation, the indication information may indicate, for example, at least one of the following.
The second link failure occurs before successful access to one cell.

The cell successfully accessed may be, for example, the target cell of the handover (for example, the DAPS handover, etc.), herein, the successful access to one cell may refer to the fact that, for example, a random access procedure in the cell is successfully completed, or an RRCReconfigurationComplete message is transmitted to the cell.

As an implementation, the indication information may indicate, for example, that the source link failure occurs before successful access to the target cell of the DAPS.
The second link failure occurs after successful access to one cell.

The cell successfully accessed may be, for example, the target cell of the handover (for example, the DAPS handover, etc.), herein, the successful access to one cell may refer to the fact that, for example, a random access procedure in the cell is successfully completed, or an RRCReconfigurationComplete message is transmitted to the cell.

As an implementation, the indication information may indicate, for example, that the source link failure occurs after successful access to the target cell of the DAPS.
The first link failure occurs after the second link failure.

As an implementation, the indication information may indicate that the source link failure occurs after the target link failure, for example.

As another implementation, the indication information may indicate that the target link failure occurs after the source link failure, for example.
The second link failure occurs before the first link failure.

As an implementation, the indication information may indicate that the source link failure occurs before the target link failure, for example.

As another implementation, the indication information may indicate that the target link failure occurs before the source link failure, for example.

(7) indication information of a type of the second link failure;

As an implementation, the indication information may indicate at least one of followings, for example.
a radio link failure;
a handover failure (for example, a DAPS handover failure, etc.);
a source link failure, i.e., indicate that the second link failure is a radio link failure that occurs in the source cell of the handover (e.g., the DAPS handover failure, etc.);
a target link failure, i.e., indicate that the second link failure is a radio link failure that occurs in the target cell of the handover (e.g., the DAPS handover failure, etc.).

(8) cause information of the second link failure;

As an implementation, the cause information of the second link failure may, for example, include at least one of followings.
timer timeout, for example, t310 timeout, etc.;
a random access failure;
reaching a maximum number of retransmission of a RLC layer;
a beam failure recovery failure.

(9) identification information of the target cell of the handover;

Herein, the identification information may be, for example, the NR CGI, and/or the PCI, and/or the carrier frequency, etc.

As an implementation, the target cell is a target cell of the DAPS handover, and the identification information of the target cell is the NR CGI, and/or the PCI, and/or the carrier frequency, etc. of the target cell of the DAPS handover.

(10) indication information of a type of the handover.

The type of the handover that the indication information may indicate includes, for example, a non-DAPS handover, a DAPS handover, and a traditional/normal handover, etc.

Of course, it can be understood that the indication information may also include, for example, a make before break handover, a non-make before break handover, a conditional handover, a non-conditional handover, etc. The present invention is not limited to this.

3. Information of the Time Length

The information of the time length may include at least one of following information.

(1) information of the time length elapsed from handover initialization to occurrence of a first link failure;

As an implementation, the handover initialization may be, for example, that a user equipment receives a handover command (e.g., a DAPS handover command, etc.).

As an implementation, the information of the time length may include, for example, information of the time length elapsed from the handover initialization (for example, receiving the DAPS handover command, etc.) to occurrence of a source link failure.

As another implementation, the information of the time length may include, for example, information of the time length elapsed from the handover initialization (e.g., receiving the DAPS handover command) to occurrence of a handover failure (e.g., a DAPS handover failure, etc.).

As yet another implementation, the information of the time length may include, for example, information of the time length elapsed from the handover initialization (e.g., receiving the DAPS handover command, etc.) to occurrence of a target link failure.

(2) information of the time length elapsed from the handover initialization to occurrence of a second link failure;

As an implementation, the handover initialization may be, for example, that the user equipment receives the handover command (e.g., the DAPS handover command, etc.).

As an implementation, the information of the time length may include, for example, information of the time length elapsed from the handover initialization (for example, receiving the DAPS handover command, etc.) to occurrence of the source link failure.

As another implementation, the information of the time length may include, for example, information of the time length elapsed from the handover initialization (e.g., receiving the DAPS handover command) to occurrence of the handover failure (e.g., the DAPS handover failure, etc.).

As yet another implementation, the information of the time length may include, for example, information of the time length elapsed from the handover initialization (e.g., receiving the DAPS handover command, etc.) to occurrence of the target link failure.

(3) information of the time length between the occurrence of the first link failure and the occurrence of the second link failure;

As an implementation, if the second link failure occurs before the first link failure, the information of the time length may include, for example, information of the time length elapsed from the occurrence of the second link failure to the occurrence of the first link failure.

As another implementation, if the second link failure occurs after the first link failure, the information of the time length may include, for example, information of the time length elapsed from the occurrence of the first link failure to the occurrence of the second link failure.

As a specific implementation, the information of the time length may include, for example, information of the time length elapsed from the occurrence of the source link failure to the occurrence of the handover failure (for example, the DAPS handover failure, etc.).

As another specific implementation, the information of the time length may include, for example, the information of the time length elapsed from the occurrence of the source link failure to the occurrence of the target link failure.

As yet another specific implementation, the information of the time length may include, for example, the information of the time length elapsed from the occurrence of the handover failure (for example, the DAPS handover failure, etc.) to the occurrence of the source link failure.

As yet another specific implementation, the information of the time length may include, for example, the information of the time length elapsed from the occurrence of the target link failure to the occurrence of the source link failure.

(4) information of the time length elapsed from successful access to the target cell of the handover (for example, successful completion of a random access procedure in the target cell, or transmission of the RRCReconfigurationComplete message to the target base station, etc.) to the occurrence of the first link failure;

As an implementation, the information of the time length may include, for example, the information of the time length elapsed from successful access to the target cell of the handover (e.g., the DAPS handover, etc.) to the occurrence of the source link failure.

As another implementation, the information of the time length may include, for example, information of the time length elapsed from successful access to the target cell of the handover (e.g., the DAPS handover, etc.) to the occurrence of the target link failure.

(5) information of the time length elapsed from successful access to the target cell of the handover (for example, successful completion of the random access procedure in the target cell, or transmission of the RRCReconfigurationComplete message to the target base station, etc.) to the occurrence of the first link failure;

As an implementation, the information of the time length may include, for example, the information of the time length elapsed from the successful access to the target cell of the handover (e.g., the DAPS handover, etc.) to the occurrence of the source link failure.

As another implementation, the information of the time length may include, for example, information of the time length elapsed from the successful access to the target cell of handover (e.g., the DAPS handover, etc.) to the occurrence of the target link failure.

(6) length of time elapsed from the occurrence of the first link failure to successful access to one cell;

As an implementation, the cell successfully accessed may be, for example, the target cell of the handover (for example, the DAPS handover, etc.), or a cell accessed by user RRC reestablishment, or a cell accessed by user RRC connection establishment, etc. Herein, the successful access to one cell may refer to the fact that, for example, a random access procedure in the cell is successfully completed, or an RRCReconfigurationComplete message is transmitted to the cell.

As an implementation, the information of the time length may include, for example, information of the time length elapsed from the occurrence of the source link failure to successful access to the target cell of the DAPS (or successful access to a cell where the user equipment is located during the RRC reestablishment, or successful access to a cell where the user equipment is located during RRC connection establishment).

(7) length of time from the occurrence of the second link failure to successful access to a cell;

As an implementation, the cell successfully accessed may be, for example, the target cell of the handover (for example, the DAPS handover, etc.), or a cell accessed by user RRC reestablishment, or a cell accessed by user RRC connection establishment, etc. Herein, the successful access to one cell may refer to the fact that, for example, a random access procedure in the cell is successfully completed, or an RRCReconfigurationComplete message, or an RRCReestablishmentComplete message, or an RRCSetupComplete message is transmitted to the cell.

As an implementation, the information of the time length may include, for example, information of the time length elapsed from the occurrence of the source link failure to the successful access to the target cell of the DAPS (or the successful access to the cell where the user equipment is located during the RRC reestablishment, or the successful access to the cell where the user equipment is located during RRC connection establishment).

(8) information of the time length elapsed from receiving the handover command (e.g., the DAPS handover command, etc.) to the successful access to the target cell of the handover(e.g., the DAPS handover, etc.) (e.g., successful completion of the random access procedure in the target cell or transmission of an RRCReconfigurationComplete message to the target base station);

(9) information of the time length for the interruption of communication with the source cell of the DAPS.

As a specific implementation, link failure related information may include, for example, at least one of following information.
measurement information of a cell obtained by a user equipment when a first link failure occurs;
first identification information of the user equipment;
identification information of a cell or PCell where the user equipment is located when a handover command is received before the first link failure (Previous Cell/PCell ID);
indication information of a cell where the user equipment is located when the first link failure occurs;
identification information of a cell where the user equipment is located when the first link failure occurs (failedPCellID);
indication information of occurrence time of the first link failure;
indication information of a type of the first link failure;
cause information of the first link failure;
second link failure information;
information of the time length;
identification information of a target cell of a handover;
indication information of a type of the handover.

Herein, the specific implementation of various types of information may be referred to the above description, and will not be described in detail here. It can be understood that the specific embodiments of the above-mentioned link failure related information are only shown as examples, and are not a limitation to this disclosure. Any combination of the above-mentioned various types of information belongs to the scope of protection of this disclosure.

4. Link Failure Related Information

The link failure related information may include at least one of following information: first link failure information; second link failure information; information of the time length.

It can be understood that “first” and “second” in the above-mentioned first link failure and second link failure are only used for naming link failures, which indicate two different link failures detected by users. The first link failure may be a radio link failure or a handover failure. Specifically, the first link failure may be a source link failure, a target link failure, or a handover failure. Similarly, the second link failure may be a radio link failure or a handover failure. Specifically, the second link failure may be a source link failure, a target link failure, or a handover failure.

Further, when the first link failure is a source link failure, the first link failure information is source link failure related information; when the first link failure is a target link failure, the first link failure information is target link failure related information; when the first link failure is a handover failure, the first link failure information is handover failure related information.

Similarly, when that second link failure is a source link failure, the second link failure information is source link failure relate information; when the second link failure is a target link failure, the second link failure information is target link failure related information; when the second link failure is a handover failure, the second link failure information is handover failure related information.

Further, the source link failure related information may be the above link failure related information, and may include at least one of following information: the first link failure information; the second link failure information; and information of the time length.

Further, the target link failure related information may be the above link failure related information, and may include at least one of following information: the first link failure information; the second link failure information; and the information of the time length.

Further, the handover failure related information may be the above link failure related information, and may include at least one of following information: the first link failure information; the second link failure information; and the information of the time length.

In addition, if more than two kinds of link failures occur during the handover, the link failure related information may also include third link failure information, fourth link failure information, etc. Definitions on the third link failure information, the fourth link failure information, and the like are similar to that on the first link failure information or the second link failure information.

5. Information Related to Link Failure Reporting

For example, the information related to link failure reporting may be the link failure related information described above, or the information related to link failure reporting may also include other information in addition to the link failure related information described above, for example, it may include at least one of following information.

identification information of a re-established cell;

information of the time length elapsed after a link failure;

information of the time length elapsed after successful access to a network;

indication information indicating a type of the link failure;

information of the time length from a source link failure to successful access of user equipment to a target cell;

information of the time length from the source link failure to a target link failure;

information of the time length from the source link failure to a handover failure;

information of the time length from the successful access of the user equipment to the target cell to the source link failure;

information of the time length from the target link failure to the source link failure;

information of the time length from the handover failure to the source link failure;

a time interval between the source link failure and the target link failure;

information of the time length on communication interruption of the user equipment;

information of the time length from initialization of handover to the successful access to the target cell;

information of the time length from the initialization of handover to occurrence of the source link failure;

indication information that the source link failure occurs before the successful access of the user equipment to the target cell;

indication information that the source link failure occurs after the successful access of the user equipment to the target cell.

Of course, other information besides these information may also be included, which is not limited by this disclosure.

Herein, it can be understood that, as an implementation, the user equipment may only record the link failure related information, and report the information related to link failure reporting, and information other than the link failure related information may be generated and reported in the reporting; as another implementation, the user equipment may record all of the information related to link failure reporting.

Combining with the above information, a processing mechanism when a link failure occurs in the above handover mechanism provided by this disclosure will be described in detail below.

Please refer to FIG. 5. FIG. 5 illustrates a flowchart of a method for recording link failure related information provided by an embodiment of the present disclosure. The method for recording link failure related information may be performed by a user equipment, and the method comprises the following steps.

S301, user equipment detects a link failure.

As an implementation, the user equipment may detect one link failure each time. For example, the user equipment may detect a first link failure, a second link failure, and so on. Specifically, the first link failure may be a source link failure, a target link failure, or a handover failure (for example, a DAPS handover failure, etc.). The second link failure may be a source link failure, a target link failure, or a handover failure (for example, a DAPS handover failure, etc.).

It can be understood that, the user equipment may acquire various types of link failures through a plurality of times of detections. For example, the user equipment may first detect the second link failure and then detect the first link failure. Specifically, we may refer to various cases shown in FIG. 4. For example, the user equipment may first detect the source link failure and then detect the handover failure (for example, the DAPS handover failure, etc.). For another example, the user equipment first detects the handover failure (for example, the DAPS handover failure, etc.), and then detects the source link failure. For yet another example, the user equipment first detects the source link failure, and then, after successfully accessing the target base station, the user equipment detects the target link failure. For yet another example, after successfully accessing the target base station, the user equipment first detects the source link failure and then detects the target link failure. For yet another example, after successfully accessing the target base station, the user equipment first detects the target link failure and then detects the source link failure, and so on.

As another implementation, the user equipment may detect a plurality of types of link failures at the same time. For example, the user equipment may detect the first link failure and the second link failure at the same time.

The specific detection method is not limited by this disclosure, for example, the detection method in the standard TS38.331 or TS36.331. It can be understood that any method capable of detecting link failure belongs to the protection scope of this disclosure.

S302, the user equipment records information related to a link failure reporting.

It can be understood that in this handover mechanism, there are various cases in which the user equipment may encounter link failures (for example, refer to the nine cases in FIG. 4, but not limited to the above nine cases, of course), and there are also various types of link failures (for example, a source link failure, a target link failure, a handover failure, etc.). Therefore, there are various implementations of the information related to link failure reporting recorded by the user equipment. For example, the information related to link failure reporting may be the link failure related information described above. For another example, the information related to link failure reporting may also include other information besides the link failure related information described above, which is not limited by this disclosure.

As an implementation, when the user equipment acquires various types of link failures through a plurality of times of detections, the user equipment may record the link failure related information (see description of the link failure related information described above for a specific implementation) related to the present detection for each time, and encapsulate the recorded link failure related information as information related to link failure reporting, so that it may be transmitted to the base station when requested by the base station or may be transmitted to the base station actively. In this way, ways in which the user equipment reports the information related to link failure reporting may become simple and times of the reporting may be reduced.

As another embodiment, the user equipment may also record, respectively, the link failure related information detected at each time as the information related to link failure reporting, and transmit, by the user equipment, the same to the base station in one or more times when needed by the base station or transmit it to the base station actively.

The following description takes a situation where the second link failure occurs before the first link failure as an example.

As a specific implementation, when the user equipment detects the second link failure, the link failure related information recorded by the user equipment may only include the second link failure information, for example; for another example, the link failure related information recorded by the user equipment may also include information of the time length, regarding the link failure related information as information related to link failure reporting.

As a specific implementation, when the user equipment detects the first link failure (which may be a source link failure, a target link failure, or a handover failure) and has not detected the second link failure before, the link failure related information recorded by the user equipment may refer to the above description, and may not include the second link failure information. The link failure related information is regarded as the information related to link failure reporting.

As a specific implementation, when the user equipment detects that the first link failure is a handover failure (for example, a DAPS handover failure) or a target link failure, and the second link failure is a source link failure, the link failure related information recorded by the user equipment may refer to the above description, and the description thereof will not be repeated here. As an example, the link failure related information may include second link failure information, and the link failure related information is regarded as the information related to link failure reporting.

As a specific implementation, when the user equipment detects that the first link failure is a source link failure, a handover failure (e.g., a DAPS handover failure) or a target link failure, the link failure related information recorded by the user equipment may refer to the above description, and the description thereof will not be repeated here. As an example, the link failure related information may include second link failure information, and the link failure related information is regarded as information related to link failure reporting.

According to the method for recording link failure related information described above, after a link failure occurs, the user equipment may record the information obtained by the user equipment when the link failure occurs. The recorded information may help the user equipment to report to the base station, and thus help the base station to discover problems of the network (such as problems of handover (for example, DAPS handover, etc.), whether the communication between the user equipment and the base station is interrupted during the handover, etc.), and further help the base station to set configuration parameters reasonably to avoid the recurrence of the problems.

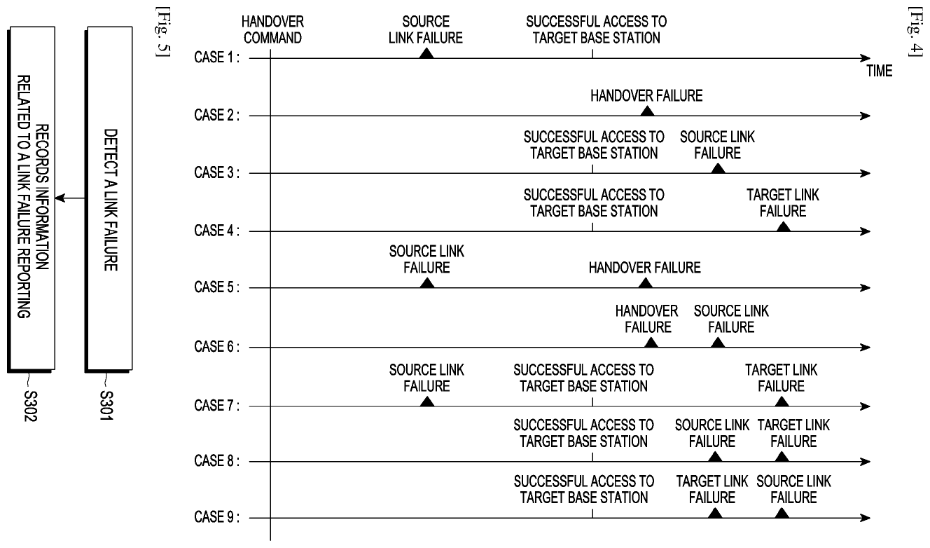

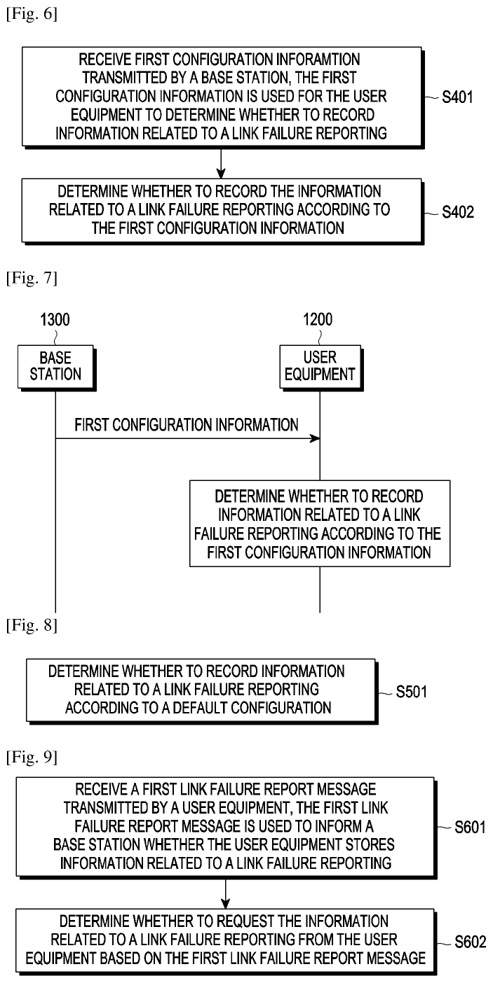

Please refer to FIG. 6 and FIG. 7. FIG. 6 illustrates a flowchart of a configuration method for a link failure provided by an embodiment of the present disclosure. FIG. 7 illustrates an interactive schematic diagram of a configuration method for a link failure provided by an embodiment of the present disclosure. The configuration method for a link failure may be performed by a user equipment, and the method includes following steps.

In S401, the user equipment 1200 receives first configuration information transmitted by a base station 1300. Herein, the first configuration information is used for the user equipment to determine whether to record information related to link failure reporting.

The base station may be, for example, a source base station, or a target base station, or other base stations besides the source base station and the target base station, or any base station in the network, etc.

As an implementation, the base station may transmit the first configuration information to the user equipment through a RRC message, such as a handover command or a handover command including a DAPS indication. As another implementation, the base station may transmit the first configuration information to the user equipment by broadcasting.

As an implementation, the first configuration information may include at least one of the following:

(1) indication information indicating whether to record link failure related information; As an implementation, the indication information may include information indicating

to record the link failure related information, or information indicating not to record the link failure related information. Specifically, the indication information may be, for example, 0/1, and if the indication information is 1, it indicates to record the link failure related information; if the indication information is 0, it indicates not to record the link failure related information; or vice versa. The user equipment may determine whether to record the link failure related information according to the indication information.

(2) indication information indicating whether to record source link failure related information during a handover (for example, a DAPS handover, etc.);

As an implementation, the indication information may include information indicating to record the source link failure related information during the handover (for example, the DAPS handover, etc.) or indicating not to record the source link failure related information during the handover (for example, the DAPS handover, etc.). Specifically, the indication information may be, for example, 0/1, and if the indication information is 1, it indicates to record the source link failure related information during the handover (for example, the DAPS handover, etc.); if the indication information is 0, it indicates not to record the source link failure related information during the handover (for example, the DAPS handover, etc.); or vice versa. The user equipment may determine whether it is necessary to record the source link failure related information during the handover (for example, the DAPS handover, etc.) according to the indication information, herein, the source link failure related information may be the link failure related information, the information of the time length, the first link failure information or the second link failure information, etc., described above.

(3) time threshold information indicating whether to record the link failure related information;

As an implementation, if a length of time obtained by the user equipment is greater than or equal to the time threshold information, the user equipment records the link failure related information, and if the length of time obtained by the user equipment is less than the time threshold information, the user equipment does not record the link failure related information. As another implementation, if a length of time obtained by the user equipment is greater than or equal to the time threshold information, the user equipment does not record the link failure related information, and if the length of time obtained by the user equipment is less than the time threshold information, the user equipment records the link failure related information.

The length of time obtained by the user equipment may be, for example, the information of the time length included in the link failure related information.

For example, in case that the length of time obtained by the user equipment is a length of time from occurrence of a source link failure of the user equipment to successful access of the user equipment to a target cell, if the length of time is less than the above-mentioned time threshold information (which means that time of communication interruption occurred before the user equipment accesses the target cell is short), the user equipment may not record the link failure related information, and on the contrary, if the length of time is greater than the above-mentioned time threshold information (which means that the time of communication interruption occurred before the user equipment accesses the target cell is long), the user equipment may record the link failure related information, such as one or more of the first link failure information, the second link failure information or the information of the time length described above.

Of course, the length of time obtained by the user equipment may also be other length of time obtained by the user equipment.

The first configuration information may help the user equipment not only determine whether to record information when the source link failure occurs during the handover (for example, the DAPS handover, etc.), but also determine whether to record information when other link failures occur, such as information when a handover failure (for example, a DAPS handover failure, etc.) occurs, information when a radio link failure (for example, a target link failure, etc.) occurs, etc.

It can be understood that the above description may be an example of the first configuration information with regard to that the first link failure or the second link failure is a source link failure, and there are also various implementations of the first configuration information.

For example, the above-mentioned indication information indicating whether to record the source link failure related information during the handover (e.g., the DAPS handover, etc.) which is included in the first configuration information is only an example, and it may also be indication information indicating whether to record other link failure information during the handover (e.g., the DAPS handover, etc.), for example, indication information indicating whether to record handover failure (e.g., a DAPS handover, etc.) information during the handover, indication information indicating whether to record target link failure related information during the handover. Herein, the handover failure (for example, a DAPS handover failure, etc.) related information or target link failure related information may be for example the link failure related information, the information of the time length, the first link failure information or the second link failure information, etc., described above.

Continue referring to FIG. 6, the method further includes step S402. In S402, the user equipment 1200 determines whether to record the information related to a link failure reporting according to the first configuration information.

For example, the user equipment may determine whether to record the information related to link failure reporting according to a value of the indication information being 1 or 0 included in the first configuration information, which indicates whether to record the link failure related information or indicates whether to record the source link failure related information during the handover (for example, the DAPS handover, etc.).

In another example, it may be determined whether to record the information related to link failure reporting according to a comparison value between the time threshold information indicating whether to record the link failure related information included in the first configuration information and the length of time obtained by the user equipment.

For another example, if the first configuration information includes two or more of the above information, it may be determined whether to record the information related to link failure reporting according to combination of the above information.

According to the above configuration method for a link failure, the user equipment may determine whether to record the information related to link failure reporting, thereby effectively controlling an amount of information stored by the user equipment.

Please refer to FIG. 8. FIG. 8 illustrates an interactive schematic diagram of a configuration method for a link failure provided by an embodiment of the present disclosure. The configuration method for a link failure may be performed by a user equipment, and the method includes following steps.

In S501, the user equipment determines whether to record information related to link failure reporting according to a default configuration.

As an implementation, the default configuration may include at least one of the following.

(1) If a source link failure occurs after the user equipment successfully accesses a target cell of a handover (e.g., a DAPS handover, etc.), as an implementation, the user equipment may not record the information related to link failure reporting, such as at least one of first link failure information, second link failure information, or information of the time length; as another implementation, the user equipment records the information related to link failure reporting, such as at least one of the first link failure information, the second link failure information, or the information of the time length.

(2) If the source link failure occurs before the user equipment successfully accesses the target cell, as an implementation, the user equipment may not record the information related to link failure reporting, such as at least one of the first link failure information, the second link failure information, or the information of the time length; as another implementation, the user equipment may record the information related to link failure reporting, such as at least one of the first link failure information, the second link failure information, or the information of the time length.

(3) If a length of time obtained by the user equipment (herein, the length of time obtained by the user equipment may be the information of the time length included in the link failure related information described above) is less than a preset time threshold (for example, a default value preset in the standard), the user equipment may not record the information related to link failure reporting, for example, at least one of the first link failure information, the second link failure information, or the information of the time length; if the length of time obtained by the user equipment is greater than the time threshold, the user equipment may not record the information related to link failure reporting, for example, at least one of the first link failure information, the second link failure information, or the information of the time length; if the length of time obtained by the user equipment is less than the time threshold, the user equipment may record the information related to link failure reporting, such as at least one of the first link failure information, the second link failure information, or the information of the time length; if the length of time obtained by the user equipment is greater than the time threshold, the user equipment may record the information related to link failure reporting, for example, at least one of the first link failure information, the second link failure information, or the information of the time length.

(4) The user equipment always records the information related to link failure reporting, such as at least one of the first link failure information, the second link failure information, or the information of the time length.

(5) The user equipment does not record the information related to link failure reporting, such as at least one of the first link failure information, the second link failure information, or the information of the time length.

According to the above default configuration, it may help the user equipment not only determine whether to record information when the source link failure occurs during the handover (for example, the DAPS handover, etc.), but also determine whether to record information when other link failures occur, such as information when a handover failure (for example, a DAPS handover failure, etc.) occurs and information when a radio link failure (for example, a target link failure, etc.) occurs.

It can be understood that the above-mentioned default configuration is only an example, and there may be various implementation of the default configuration. For example, the source link failure in the above default configuration may be replaced by the target link failure or the handover failure (for example, a DAPS handover failure, etc.) to form other default configuration, which will not be described in detail, and the disclosure is not limited to this.

According to the above configuration method for a link failure, the user equipment may determine whether to record the information related to link failure reporting, thereby effectively controlling an amount of information stored by the user equipment.

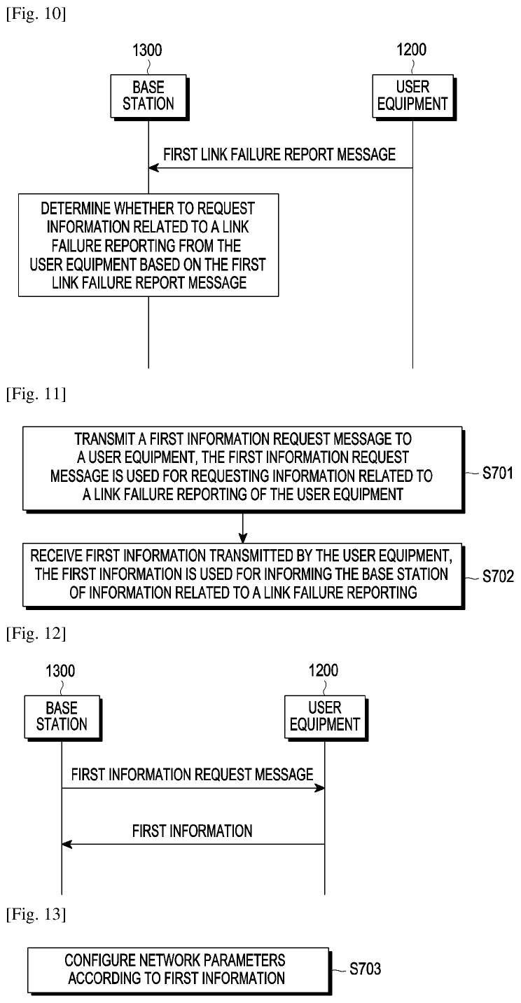

Please refer to FIG. 9 and FIG. 10. FIG. 9 illustrates a flow chart of a method for link failure reporting provided by an embodiment of the present disclosure. FIG. 10 illustrates an interactive schematic diagram of a method for link failure reporting provided by an embodiment of the present disclosure. The method for link failure reporting may be performed by a base station, and the method comprises following steps.

In S601, the base station 1300 receives a first link failure report message transmitted by a user equipment 1200. Herein, the first link failure report message is used to inform a base station whether the user equipment stores information related to link failure reporting.

As an implementation, the first link failure report message may be an existing RRC message, such as one or more of RRCSetupComplete, RRCReestablishmentComplete, RRCResumeComplete and RRCReconfigurationComplete.

As another implementation, the first link failure report message may also be a new RRC message. Specifically, the first link failure report message may include at least one of the following information:

(1) indication information indicating whether the link failure related information is stored or not;

In an implementation, the indication information may be, for example, rIfInfoAvailable indication information defined in the standard TS38.331 or TS36.331.

As another implementation, the indication information may include information indicating that the link failure related information has been stored, or information indicating that the link failure related information has not been stored. Specifically, the indication information may be 0/1, for example, and if the indication information is 1, it indicates that the link failure related information has been stored; if the indication information is 0, it indicates that the link failure related information has not been stored; or vice versa.

(2) indication information indicating whether the source link failure related information is stored;

In an implementation, the indication information may be, for example, source RLF information available.

As another implementation, the indication information may include indication information indicating that the source link failure related information has been stored, or indication information indicating that the source link failure related information has not been stored. Specifically, the indication information may be 0/1, for example, and if the indication information is 1, it indicates that the source link failure related information has been stored; if the indication information is 0, it indicates that the source link failure related information has not been stored; and vice versa. Herein, the source link failure related information may be, for example, the link failure related information, the information of the time length, the first link failure information or the second link failure information, etc., described above.

The indication information may help the base station to obtain at least one of following information: 1) the source link failure has occurred during a handover (for example, a DAPS handover, etc.) of the user equipment; or 2) the user equipment has recorded the source link failure related information. With this indication information, it may be indicated whether the user equipment has stored the source link failure related information during a handover (e.g., a DAPS handover, etc.), which is different from the way in which the rIf-InfoAvailable indication information is used to indicate whether to store the link failure related information.

As an implementation, before step S601, the base station transmits second configuration information to the user equipment. Herein, the second configuration information is used for the user equipment to determine whether the first link failure report message includes the indication information indicating whether to store the source link failure related information. According to the second configuration information, the user equipment determines whether the first link failure report message includes the indication information indicating whether the source link failure related information is stored.

As an implementation, the base station transmits the second configuration information to the user equipment. Herein, the second configuration information includes time threshold information for the user equipment to determine whether the first link failure report message includes the indication information indicating whether the source link failure related information is stored.

As an implementation, if a length of time obtained by the user equipment (which may be the information of the time length included in the above link failure related information) is greater than the threshold information, the user equipment determines that the first link failure report message includes the indication information indicating whether the source link failure related information is stored; if the length of time obtained by the user equipment is less than the threshold information, the user equipment determines that the first link failure report message does not include the indication information indicating whether he source link failure related information is stored.

As another implementation, if the length of time obtained by the user equipment is greater than the threshold information, the user equipment determines that the first link failure report message does not include the indication information indicating whether the source link failure related information is stored; if the length of time obtained by the user equipment is less than the threshold information, the user equipment determines that the first link failure report message includes the indication information indicating whether the source link failure related information is stored.

Specifically, assuming that the length of time obtained by the user equipment is a length of time from the source link failure of the user equipment to successful access of the user equipment to a target cell, if the length of time is less than the threshold information (which means that the time of communication interruption occurred before the access of the user equipment to the target cell is short), the user equipment determines that the first link failure report message does not include the indication information indicating whether the source link failure related information is stored; if the length of time is greater than the threshold information (which means that the time of communication interruption occurred before the access of the user equipment to the target cell is long), the user equipment determines that the first link failure report message includes the indication information indicating whether the source link failure related information is stored.

In S602, the base station 1300 determines whether to request the information related to link failure report from the user equipment 1200 based on the first link failure report message.

For example, it may be determined whether to request the information related to link failure reporting from the user equipment according to a value of the indication information being 1 or 0 included in the first link failure report message, which indicates whether the link failure related information is stored and/or indicates whether the source link failure related information is stored.

According to the above method for link failure reporting, the base station may know whether the user equipment stores the information related to link failure reporting, and further, the base station may decide whether to request the link failure related information stored by the user equipment.

Please refer to FIG. 11 and FIG. 12. FIG. 11 illustrates a flow chart of method for link failure reporting provided by an embodiment of the present disclosure. FIG. 12 illustrates an interactive schematic diagram of a method for link failure reporting provided by an embodiment of the present disclosure. The method for link failure reporting may be performed by a base station, and the method comprises following steps.

In S701, a base station 1300 transmits a first information request message to a user equipment 1200, and the first information request message is used to request information related to link failure reporting of the user equipment 1200.

As an implementation, the first information request message may include at least one of the following information:

(1) indication information for requesting to report link failure related information;

The indication information is used to request the user to report the stored link failure related information.

As an implementation, the indication information may be, for example, rIfReportReq in a UEInformationRequest message in the standard TS38.331.

As another implementation, the indication information may be, for example, new indication information for requesting the user equipment to report the link failure related information, which may include information which is related to all link failures. For example, if the user equipment stores information which is related to two link failures (e.g., a first link failure and a second link failure), the indication information indicates the user equipment to report link failure related information which is related to the two link failures, such as first link failure information, second link failure information and information of the time length. In another example, if the user equipment stores information which is related to three link failures (e.g., a first link failure, a second link failure and a third link failure), the indication information indicates the user equipment to report link failure related information which is related to the three link failures, such as first link failure information, second link failure information, third link failure information and information of the time length.

(2) indication information for requesting to report source link failure related information;

The indication information is used to request the user equipment to report the stored source link failure related information, herein, the source link failure related information may be the link failure related information, the information of the time length, the first link failure information or the second link failure information, etc., described above. As an implementation, the source link failure is a source link failure that occurs during a handover (for example, a DAPS handover, etc.) of the user equipment.

(3) indication information for requesting to report target link failure related information;

The indication information is used to request the user equipment to report its stored target link failure related information, herein, the target link failure related information may be the link failure related information, the information of the time length, the first link failure information or the second link failure information, etc. , described above. As an implementation, the target link failure is a target link failure that occurs during the handover (for example, the DAPS handover, etc.) of the user equipment.

(4) indication information for requesting to report handover failure related information;

The indication information is used to request the user equipment to report its stored handover failure related information, herein, the handover failure related information may be, for example, the first link failure information or the second link failure information, etc., described above. As an implementation, the handover failure is a failure that occurs when accessing a target cell during the handover (for example, DAPS handover, etc.) of the user equipment.

According to the above steps, the base station may request the link failure related information from the user equipment, and the user equipment may provide the base station with relevant information on one or more link failures detected by the user equipment; when the user equipment performs the handover (for example, the DAPS handover, etc.), the base station may obtain the relevant information on one or more link failures detected during the handover of the user equipment. When the user equipment performs the handover (for example, the DAPS handover, etc.), if only the source link failure occurs, the base station may obtain the source link failure related information.

In S702, the base station 1300 receives first information transmitted by the user equipment 1200, the first information is used to inform the base station of the information related to link failure reporting.

As an implementation, the first information may include at least one of the following information:

(1) link failure related information;

Herein, a link failure targeted by the link failure related information may be a source link failure, a target link failure, or a handover failure (e.g., a DAPS handover failure, etc.), etc. One can refer to the above description for specific content of the link failure related information, and the details thereof are not repeated here.

(2) first link failure information or second link failure information;

Herein, a link failure targeted by the first link failure information or the second link failure information may be a source link failure, a target link failure, or a handover failure (for example, a DAPS handover failure, etc.), etc. One can refer to the above description for specific content of the first link failure information or the second link failure information, and the details thereof are not repeated here.

(3) identification information of a re-established cell;

Herein, the identification information of the re-established cell may be, for example, NR CGI, and/or PCI, and/or carrier frequency, etc., which indicates a cell where the user equipment is located when performing cell reestablishment (for example, when transmitting a reestablishment request message), and the re-established cell is a cell where the user equipment performs reestablishment after a link failure occurs;

(4) information of the time length elapsed after a link failure;

Herein, the information is used to indicate a length of time elapsed from occurrence of the link failure to transmission of the first information by the user equipment.

As an implementation, the length of time may be, for example, a length of time elapsed from occurrence of the source link failure to the transmission of the first information by the user equipment during the handover (e.g., the DAPS handover, etc.).

As another implementation, the length of time may be, for example, a length of time elapsed from occurrence of the target link failure (or the handover failure (e.g., the DAPS handover failure, etc.)) to the transmission of the first information by the user equipment during the handover (e.g., the DAPS handover, etc.).

As another implementation, the length of time may be, for example, timeSinceFailure in the standard TS38.331.

(5) information of the time length elapsed for successful access to a network;

Herein, the information is used to indicate a length of time elapsed from the occurrence of the link failure to the access to a cell by the user equipment.

As an implementation, the length of time may be, for example, a length of time elapsed from the occurrence of the source link failure to the access to the cell by the user equipment during the handover (e.g., the DAPS handover, etc.).

As another implementation, the length of time may be, for example, a length of time elapsed from the occurrence of the target link failure (or the handover failure (e.g., the DAPS handover failure, etc.)) to the access to the cell by the user equipment during the handover (e.g., the DAPS handover, etc.).

(6) indication information indicating a type of the link failure;

Herein, the type indicated by the indication information may include, for example, the source link failure during the handover (for example, the DAPS handover), the target link failure during the handover (for example, the DAPS handover), the handover (for example, the DAPS handover) failure, etc.

(7) information of the time length elapsed from the source link failure to the successful access to the target cell by the user equipment;

(8) information of the time length elapsed from the source link failure to the target link failure;

(9) information of the time length elapsed from the source link failure to the handover failure (for example, the DAPS handover failure, etc.);

(10) information of the time length elapsed from the successful access to the target cell by the user equipment to the source link failure;

(11) information of the time length elapsed from the target link failure to the source link failure;

(12) information of the time length elapsed from the handover failure (for example, the DAPS handover failure, etc.) to the source link failure;

(13) a time interval between the source link failure and the target link failure (or the handover failure (for example, the DAPS handover failure, etc.));

(14) information of the time length on communication interruption of the user equipment;

(15) information of the time length elapsed from initialization of handover to the successful access to the target cell;

(16) information of the time length elapsed from the initialization of handover to the source link failure;

(17) indication information indicating that the source link failure occurs before the successful access of the user equipment to the target cell;

(18) indication information indicating that the source link failure occurs after the successful access of the user equipment to the target cell.

As another implementation, if only the source link failure occurs during the handover (for example, the DAPS handover, etc.) of the user equipment, the first information transmitted by the user equipment may include at least one of the following information:

(1) source link failure related information;

The source link failure related information may be the above-mentioned link failure related information, information of the time length, first link failure information or second link failure information, etc.

(2) indication information indicating that the type of the link failure is the source link failure during the handover (for example, the DAPS handover, etc.);

(3) indication information indicating that a cell where the link failure occurs is a source cell during the handover (for example, the DAPS handover, etc.);

(4) identification information of a cell where the user equipment is located when the link failure occurs, that is, identification information of the source cell of the handover (for example, the DAPS handover, etc.);

(5) information of the time length elapsed from the source link failure to the successful access of the user equipment to the target cell;

(6) information of the time length elapsed from the initialization of handover to the successful access to the target cell;

(7) information of the time length elapsed from the initialization of handover to the source link failure.

As an implementation, please refer to FIG. 13, the above method for link failure reporting may further comprises: step S703, the base station 1300 configures network parameters according to the first information.

As another implementation, please refer to FIG. 14, the above method for link failure reporting may further include: step S704, the base station 1300 transmits information included in the first information to another base station to enable the another base station to configure network parameters.

According to the above method for link failure reporting, the base station may request the information related to link failure reporting from the user equipment, and the user equipment may provide the base station with relevant information on one or more link failures detected by the use equipment; when the user equipment performs the handover (for example, the DAPS handover, etc.), the base station may obtain the relevant information on one or more link failures detected during the handover of the user equipment; when the user equipment performs the handover (for example, the DAPS handover, etc.), if only the source link failure occurs, the base station may obtain the information related to link failure reporting; the base station may set the network parameters according to the received first information or forward the received first information to the another base station; further, the base station may determine whether the user equipment encounters the source link failure during the handover (e.g., the DAPS handover, etc.), and time for user communication interruption caused by the source link failure, etc. According to this information, the base station may know whether parameters of the handover (e.g., the DAPS handover, etc.) set by itself are appropriate, and whether the selected target cell of the handover is appropriate, etc., so as to help the base station optimize handover parameter configuration.

It can be understood that in the above method for link failure reporting, the step S701 may be omitted, that is, the user equipment may actively transmit the first information to the base station, without transmitting the first information after receiving the first information request message transmitted by the base station.

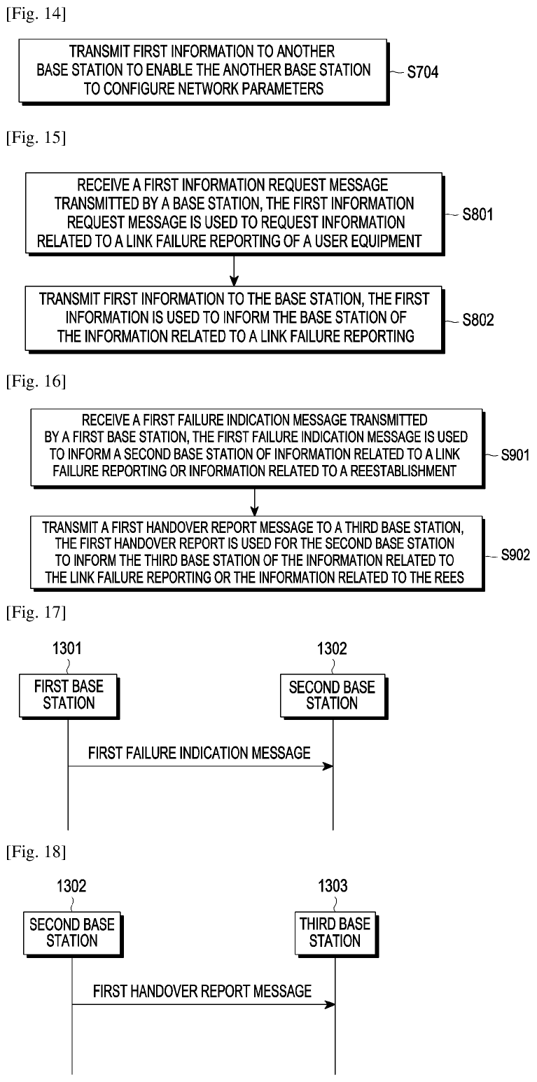

Please refer to FIG. 15, which illustrates a flow chart of a method for link failure reporting provided by an embodiment of the present disclosure, the method for link failure reporting may be performed by a user equipment, and the method comprises following steps.

In step S801, the user equipment receives a first information request message transmitted, herein, the first information request message is used to request information related to link failure reporting of the user equipment.

In step S802, the user equipment transmits the first information to the base station, herein, the first information is used to inform the base station of the information related to link failure reporting.

If the information related to the link failure reporting of the user equipment, which is requested by the first information request message transmitted by the base station, is not stored by the user equipment, the user equipment may ignore the first information request message without transmitting the first information.

It can be understood that in the above method for link failure reporting, step S801 may be omitted, that is, the user equipment may actively transmit the first information to the base station without transmitting it after receiving the first information request message transmitted by the base station.

Among them, the parts similar to those in the previous embodiment will not be described again.

According to the above method for link failure reporting, the base station may request the information related to link failure reporting from the user equipment, and the user equipment may provide the base station with relevant information on one or more link failures detected by the use equipment; when the user equipment performs the handover (for example, the DAPS handover, etc.), the base station may obtain the relevant information on one or more link failures detected during the handover of the user equipment; when the user equipment performs the handover (for example, the DAPS handover, etc.), if only the source link failure occurs, the base station may obtain information of the source link failure; the base station may set the network parameters according to the received information or forward the received information to another base station; further, the base station may determine whether the user equipment encounters the source link failure during the handover (e.g., the DAPS handover, etc.), and time for user communication interruption caused by the source link failure, etc. According to this information, the base station may know whether parameters of the handover (e.g., the DAPS handover, etc.) set by itself are appropriate, and whether the selected target cell of the handover is appropriate, etc., so as to help the base station optimize handover parameter configuration.

Please refer to FIG. 16, FIG. 17 and FIG. 18. FIG. 16 illustrates a flow chart of a forwarding method for link failure information, FIG. 17 illustrates a schematic diagram of interaction between a first base station and a second base station in a forwarding method for link failure information provided by an embodiment of the present disclosure, and FIG. 18 illustrates a schematic diagram of interaction between a second base station and a third base station in a forwarding method for link failure information provided by an embodiment of the present disclosure. The forwarding method for the link failure information may be performed by the second base station, and the method comprises following steps.

In step S901, the second base station 1302 receives a first failure indication message transmitted by a first base station 1301, herein, the first failure indication message is used to inform the second base station 1302 of information related to link failure reporting of user equipment or information related to reestablishment.

The content included in the first failure indication message may be, for example, a Failure Indication message in the standard TS38.331, or a RLF Indication message in the standard TS36.331, or a Handover Report message in the standards TS38.423 and TS36.423, or a newly defined message as follows.

As one of the above modes, the first failure indication message may also include at least one of the following information:

(1) information related to link failure reporting of the user equipment, for the content included in this information, one can refer to at least one of the link failure related information, the information of the time length, the first link failure information, or the second link failure information, described above;

(2) source link failure related information, for the content included in this information, one can refer to at least one of the link failure related information, the information of the time length, the first link failure information, or the second link failure information, described above;

(3) target link failure related information, for the content included in this information, one can refer to at least one of the link failure related information, the information of the time length, the first link failure information, or the second link failure information, described above;

(4) information related to a handover failure (for example, a DAPS handover failure, etc.), for the content included in this information, one can refer to at least one of the link failure related information, the information of the time length, the first link failure information, or the second link failure information, described above;

(5) indication information indicating that a type of the link failure is a source link failure during a handover (for example, a DAPS handover, etc.);

(6) indication information indicating that a cell where the link failure occurs is a source cell during the handover (for example, the DAPS handover, etc.);

(7) indication information indicating occurrence timing of the source link failure, for example, indicating that the source link failure occurs before or after successful access to a target cell;

(8) identification information of a cell where the user equipment is located when the link failure occurs, for example, identification information of the source cell of the handover (for example, the DAPS handover, etc.);

(9) information of the time length of time length elapsed from the source link failure to successful access of the user equipment to a target cell, which may help the second base station to know a length of time of communication interruption elapsed by the user equipment during the handover;

(10) information of the time length elapsed from initialization of the handover to the successful access to the target cell, which may help the second base station to know a length of time of communication interruption elapsed by the user equipment during the handover;

(11) information of the time length elapsed from the initialization of the handover to the source link failure, which may help the second base station to know a length of time of communication interruption elapsed by the user equipment during the handover.

As a specific embodiment, in the case that the user equipment only detects the source link failure during the handover (for example, the DAPS handover, etc.), the second base station is a base station of the target cell of the user equipment when performing the handover (for example, the DAPS handover, etc.), and the first base station is a base station of the source cell of the user equipment when performing the handover (for example, the DAPS handover, etc.), then the first failure indication message may include at least one of the following information:

(1) source link failure related information, for content included in this information, one can refer to at least one of the link failure related information, the information of the time length, the first link failure information, or the second link failure information, described above;

(2) indication information indicating that a type of the link failure is a source link failure during a handover (for example, a DAPS handover, etc.);

(3) indication information indicating that a cell where the link failure occurs is a source cell during the handover (for example, the DAPS handover, etc.);

(4) indication information indicating occurrence timing of the source link failure, for example, indicating that the source link failure occurs before or after successful access to a target cell;

(5) indication information of a cell where the user equipment is located when the link failure occurs, for example, identification information of the source cell of the handover (for example, the DAPS handover, etc.);

(6) information of the time length elapsed from the source link failure to the successful access of the user equipment to the target cell;

(7) information of the time length elapsed from initialization of handover to the successful access to the target cell;

(8) information of the time length elapsed from the initialization of handover to the source link failure.

As another specific embodiment, when the user equipment only detects the target link failure or the handover failure (e.g., the DAPS handover failure) during the handover, the content included in the first failure indication message may be, for example, a Failure Indication message in standard TS38.331 or an RLF Indication message in TS36.331 However, the information related to link failure included in the first failure indication message may refer to at least one of the link failure related information, the information of the time length, the first link failure information, or the second link failure information, described above.

According to the above method, it may help another base station to obtain information related to link failure reporting detected by user equipment; it may help the base station to know the information related to the source link failure during the handover (for example, the DAPS handover, etc.); it may help the base station to optimize settings of parameters during the handover (e.g., the DAPS handover, etc.), and/or select the target cell, and/or determine whether to adopt the DAPS handover, etc. Further, the base station may determine whether the source link failure occurs during the handover (e.g., the DAPS handover, etc.) of the user equipment, and the time of communication interruption of the user equipment caused by the source link failure, etc. According to this information, the base station may know whether the parameters of the handover (e.g., the DAPS handover, etc.) set by itself are appropriate, and whether the selected target cell of the handover (for example, the DAPS handover, etc.) is suitable, so as to help the base station optimize handover (for example, the DAPS handover, etc.) parameter configuration.

Furthermore, in the actual situation, after the second base station receives the first failure indication message transmitted by the first base station, the second base station is not a base station causing the link failure, so the second base station may process the first failure indication message, determine a cause for the link failure, and generate a first handover report message to transmit to the third base station.

In a specific embodiment, after receiving the first failure indication message, the second base station may determine that the cause for the link failure as too early handover, too late handover, or handover to a wrong cell, etc. Then the second base station transmits the cause information and some or all of information included in the first failure indication message to the third base station, and finally the third base station solves problems of the link failure, for example, to adjust the parameters of the handover.

Please continue to refer to FIG. 11, the forwarding method for link failure information may further comprise: step 902, the second base station transmits the first handover report message to the third base station, herein, the first handover report is used for the second base station to inform the third base station of the information related to a link failure reporting or the information related to a reestablishment.

The first handover report message may be a Handover Report message in standards TS38.423 and TS36.423, a Failure Indication message in standard TS38.423, an RLF Indication message in TS36.423, or a newly defined message.

As an implementation, the first handover report message may include at least one of the following:

(1) indication information of a type of the link failure, the type indicated by the indication information may include, for example, the source link failure during the handover (e.g., the DAPS handover, etc.), the target link failure during the handover (e.g., the DAPS handover, etc.), the handover (e.g., the DAPS handover, etc.) failure, too early handover, too late handover, handover to a wrong cell, etc;

(2) indication information indicating occurrence of the source link failure, this indication information is used to inform the third base station that the source link failure occurs when the user equipment performs the handover (for example, the DAPS handover, etc.);

(3) information related to the link failure of the user equipment, for example, may be the ink failure related information, the information of the time length, the first link failure information or the second link failure information, etc., described above;

(4) source link failure related information, for example, may be the link failure related information, the information of the time length, the first link failure information or the second link failure information, etc., described above;

(5) target link failure related information, for example, may be the link failure related information, the information of the time length, the first link failure information or the second link failure information, etc., described above;

(6) information related to the handover failure (for example, the DAPS handover failure, etc.), for example, may be the link failure related information, the information of the time length, the first link failure information or the second link failure information, etc., described above;

(7) information related to mobility,

Herein, the information is used to indicate configuration information used when the user equipment performs the handover, for example, information transmitted by the source base station to the target base station when the user equipment performs the handover; further, the information related to mobility may be information related to the handover (e.g., the DAPS handover, etc.), the information is used to indicate configuration information used when the user equipment performs the handover (e.g., the DAPS handover, etc.), and the information may be transmitted by the source base station to the target base station when the user equipment performs the handover.

(8) indication information indicating that the type of the link failure is the source link failure during the handover (for example, the DAPS handover, etc.);

(9) indication information indicating that a cell where the link failure occurs is a source cell during the handover (for example, the DAPS handover, etc.);

(10) indication information indicating occurrence timing of the source link failure, for example, indicating that the source link failure occurs before or after successful access to a target cell;

(11) identification information of a cell where the user equipment is located when the link failure occurs, that is, identification information of the source cell of the handover (for example, the DAPS handover, etc.);

(12) information of the time length elapsed from the source link failure to the successful access to the target cell by the user equipment, which may help the third base station to know a time length of the communication interruption experienced by the user equipment during the handover;

(13) information of the time length elapsed from initialization of the handover to the successful access to the target cell, which may help the third base station to know a length of time for communication interruption elapsed by the user equipment during the handover;

(14) information of the time length elapsed from the initialization of the handover to the source link failure, which may help the third base station to know a time length of communication interruption experienced by the user equipment during the handover;

(15) information included in Handover Report in standards TS38.423 and TS36.423.

According to the above method, it may help another base station to obtain information related to link failure reporting detected by user equipment; it may help the base station to know the information related to the source link failure during the handover (for example, the DAPS handover, etc.); it may help the base station to optimize settings of parameters during the handover (e.g., the DAPS handover, etc.), and/or select the target cell, and/or determine whether to adopt the DAPS handover, etc. Further, the base station may determine whether the source link failure occurs during the handover (e.g., the DAPS handover, etc.) of the user equipment, and the time of communication interruption of the user equipment caused by the source link failure, etc. According to this information, the base station may know whether the parameters of the handover (e.g., the DAPS handover, etc.) set by itself are appropriate, and whether the selected target cell of the handover (for example, the DAPS handover, etc.) is suitable, so as to help the base station optimize handover (for example, the DAPS handover, etc.) parameter configuration.

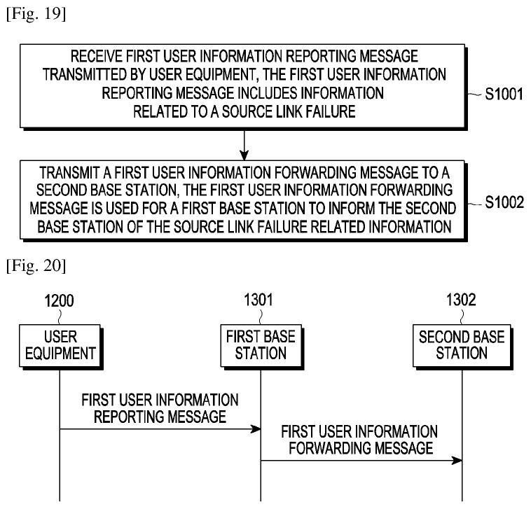

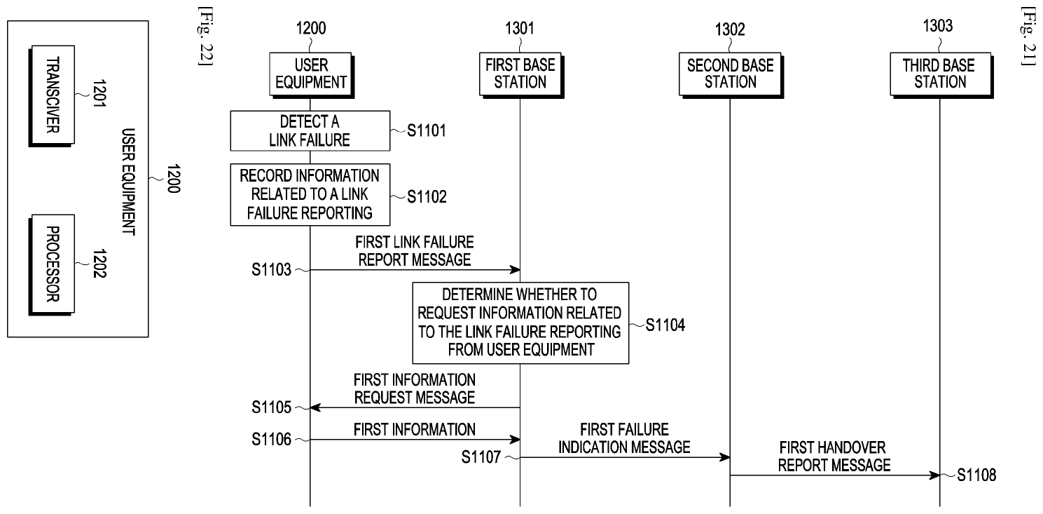

Please refer to FIG. 19 and FIG. 20. FIG. 19 illustrates a flow chart of a method for link failure reporting provided by an embodiment of the present disclosure, and FIG. 20 illustrates an interactive schematic diagram of a method for link failure reporting provided by an embodiment of the present disclosure. The method for link failure reporting may be performed by a first base station, and the method comprises the following steps.

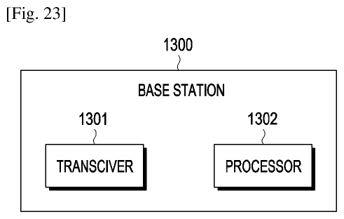

In step S1001: the first base station 1301 receives a first user information reporting message transmitted by a user equipment 1200, herein, the first user information reporting message includes source link failure related information. The first user information reporting message may be a first link failure report message of step S1103 or first information of step S1106 in FIG. 21

As an implementation, the first base station may be, for example, a base station of a target cell of the user equipment when performing a handover.

As an implementation, the first user information reporting message may be, for example, an RRC message, such as the RRCReconfigurationComplete in the standards TS38.331, or TS36.331, or other existing RRC messages.

As another implementation, the first user information reporting message may be a newly defined RRC message. Specifically, the first user information reporting information may include, for example, at least one of the following:

(1) indication information of occurrence of a source link failure;

(2) link failure related information, for this information, one can refer to at least one of the link failure related information, the information of the time length, the first link failure information, or the second link failure information, described above;

(3) indication information of occurrence timing of the source link failure;

Herein, as an implementation, the indication information may be, for example, that the source link failure occurs before a successful access to the target cell; as another implementation, the indication information may be, for example, that the source link failure occurs after the successful access to the target cell. Herein, the successful access to the target cell may be, for example, successful completion of a random access procedure in the target cell, or transmission of an RRCReconfigurationComplete message to the base station by the user equipment.

(4) information of the time length elapsed from the source link failure to the successful access to the target cell by the user equipment, which may help the first base station to know a time length of the communication interruption experienced by the user equipment during the handover;

(5) information of the time length elapsed from initialization of handover to the successful access to the target cell, which may help the first base station to know a time length of the communication interruption experienced by the user equipment during the handover;

(6) information of the time length elapsed from the initialization of handover to the source link failure, which may help the first base station to know a time length of the communication interruption experienced by the user equipment during the handover;

(7) information of the time length on communication interruption of the user equipment

In this way, the first base station may know that the user equipment has encountered the source link failure, and further, the first base station does not need to transmit indication information of releasing the source link to the user equipment.

In step S1002, the first base station 1301 transmits a first user information forwarding message to the second base station 1302, wherein the first user information forwarding message is used for the first base station 1301 to inform the second base station 1302 of the source link failure related information. The first user information forwarding message may be a first failure indication message of step S1107 illustrated in FIG. 21.

As an implementation, the second base station may be, for example, a source base station of the user equipment during the handover.

As an implementation, the first user information forwarding message may have the same information content as the first user information reporting message.

As an implementation, the first user information forwarding message may be, for example, a Failure Indication message in the standard TS38.331, an RLF Indication message in the standard TS36.331, a HO Success message, or other existing X2/Xn interface messages, etc.

As another implementation, the first user information forwarding message may also be a new X2/Xn interface message, for example. Specifically, the first user information forwarding message may include at least one of the following information:

(1) indication information of releasing the source link, which is used to inform the second base station that it may release configuration of the user and/or stop communication with the user.

(2) indication information of occurrence of the source link failure;

(3) link failure related information, for this information, one can refer to at least one of the link failure related information, the first link failure information, or the second link failure information, described above;

(4) indication information of occurrence timing of the source link failure;

One embodiment of the indication information is that the source link failure occurs before successful access to a target cell, and another embodiment is that the source link failure occurs after the successful access to the target cell. One example of the successful access to the target cell is successful completion of a random access procedure in the target cell, and another example is that the user transmits an RRCReconfigurationComplete message to the base station.

(5) information of the time length elapsed from the source link failure to the successful access to the target cell by the user, which may help the second base station to know a time length of communication interruption experienced by the user equipment during a handover;

(6) information of the time length elapsed from initialization of handover to the successful access to the target cell, which may help the second base station to know a time length of communication interruption experienced by the user equipment during a handover;

(7) information of the time length elapsed from the initialization of handover to the source link failure, which may help the second base station to know a time length of communication interruption experienced by the user equipment during a handover;

(8) information of the time length on communication interruption of the user equipment.

It can be understood that, in the handover mechanism of this disclosure, it may happen that the user equipment encounters the source link failure during the handover (for example, the DAPS handover), and the user equipment successfully accesses to the target cell. Specifically, there are two cases: 1) the source link failure occurs before the successful access to the target cell by the user equipment, and 2) the source link failure occurs after the successful access to the target cell by the user equipment. In the above two cases, the method for link failure reporting may help the base station to know that the user equipment has occurred the source link failure.

Further, the method for a link failure reporting may help the base station to obtain the source link failure related information; it may help the base station to configure parameters of the handover of the user equipment. For example, if the second base station knows that the user equipment encounters the source link failure and after knowing the information of the time length elapsed from the source link failure to the access to the target cell by the user equipment, the second base station may determine whether the user encounters communication interruption during the handover (for example, the DAPS handover, etc.). Further, it may determine the time length of the communication interruption of the user equipment, thus helping the second base station to determine settings of parameters of the handover (for example, DAPS handover, etc.) or selection of the target cell, etc.

It can be understood that the above embodiments may be used in combination, and some steps in each embodiment may be omitted or deleted when combining the individual embodiments, and the steps in each embodiment are not limited when combining, and any combination way belongs to the scope of protection of the present invention. The following will be described with a specific example.

Please refer to FIG. 21, which illustrates a timing chart of a method for link failure reporting provided by an embodiment of the present disclosure.

In step S1101, the user equipment 1200 detects a link failure.

In step S1102, the user equipment 1200 records information related to a link failure reporting.

In step S1103: the first base station 1301 receives a first link failure report message from the user equipment 1200, herein, the first link failure report message is used to inform the base station whether the user equipment stores information related to the link failure reporting.

In step S1104, in response to the first link failure report message, the first base station 1301 determines whether to request the information related to the link failure reporting from the user equipment 1200.

In step S1105, the first base station 1301 transmits a first information request message to the user equipment 1200, herein, the first information request message is used to request the information related to the link failure reporting. The first base station may be a base station which the UE reconnects after a link failure.

In step S1106, the first base station 1301 receives the first information transmitted by the user equipment 1201, herein, the first information is used to inform the base station of the information related to the link failure reporting.

In step S1107, the first base station 1301 transmits a first failure indication message to a second base station 1302, herein, the first failure indication message is used for the first base station to inform the second base station of the information related to the link failure reporting of user equipment or information related to a reestablishment. The second base station may be a base station of a target cell and the third base station may be a base station of a source cell.

In step S1108, the second base station 1302 transmits a first handover report message to a third base station 1303, herein, the first handover report is used for the second base station to inform the third base station of the information related to link failure reporting or the information related to a reestablishment.

For specific implementation of the above steps, one can refer to description of the steps in the previous embodiments, and they will not be repeated here. In addition, the order of the above steps may be changed, and the above steps are not necessary, for example, some steps may not be performed in the actual system.

According to the above method, the user equipment may determine whether to record the information related to link failure reporting detected by the user equipment; the user equipment may indicate to a network side that it stores the information related to link failure reporting; the base station may request the information related to link failure reporting from the user equipment; the user equipment may provide the information related to link failure reporting to the base station; after receiving the information related to link failure of the user equipment, the base station may adjust network parameter configuration or handover configuration of the user equipment; after receiving the information related to the link failure, the base station may forward it to another base station.

Furthermore, the above link failure may be a radio link failure, a handover failure (for example, a DAPS handover failure), a source link failure during a handover (for example, a DAPS handover failure), a target link failure during a handover (for example, a DAPS handover failure), or other types of link failures.

Furthermore, according to the above method, the base station may determine whether the source link failure occurs during the handover (e.g., the DAPS handover) of the user equipment, the time of communication interruption of the user equipment caused by the source link failure, etc. According to this information, the base station may know whether the parameters of the handover (e.g., the DAPS handover, etc.) set by itself are appropriate, and whether the selected target cell of the handover (for example, the DAPS handover, etc.) is suitable, so as to help the base station optimize handover (for example, the DAPS handover, etc.) parameter configuration.

FIG. 22 is a block diagram illustrating the structure of a user equipment 1200 according to an embodiment of the present disclosure.

Referring to FIG. 22, the user equipment 1200 includes a transceiver 1201 and a processor 1202. The transceiver 1201 is configured to transmit and receive signals to and from outside. The processor 1202 is configured to perform the above method for link failure reporting, the configuration method for a link failure or the method for recording link failure related information. The user equipment 1200 may be implemented in the form of hardware, software or a combination of hardware and software, so that it may perform the above-mentioned method for link failure reporting, the configuration method for a link failure or the method for recording link failure related information described in this disclosure.

FIG. 21 is a block diagram illustrating the structure of a base station 1300 according to an embodiment of the present disclosure.

Referring to FIG. 21, the base station 1300 includes a transceiver 1301 and a processor 1302. The transceiver 1301 is configured to transmit and receive signals to and from outside. The processor 1302 is configured to perform the above method for link failure reporting, or the forwarding method for link failure information. The base station 1300 may be implemented in the form of hardware, software or a combination of hardware and software, so that it may perform the above-mentioned method for link failure reporting, or the forwarding method for link failure information.

At least one embodiment of the present disclosure also provides a non-transitory computer-readable recording medium having stored thereon a program, which when executed by a computer, performs the methods described above.

Various embodiments of the present disclosure may be implemented as computer readable code embodied on a computer readable recording medium from a specific perspective. A computer-readable recording medium may be any data storage device that may store data readable by a computer system. Examples of the computer-readable recording medium may include a read-only memory (ROM), a random access memory (RAM), a compact disk read-only memory (CD-ROM), a magnetic tape, a floppy disk, an optical data storage device, carrier wave (e.g., data transmission via the Internet), and the like. Computer readable recording media may be distributed by computer systems connected via a network, and thus the computer readable code may be stored and executed in a distributed manner. Furthermore, functional programs, codes, and code segments for implementing various embodiments of the present disclosure may be easily explained by those skilled in the art to which the embodiments of the present disclosure are applied.

It will be understood that embodiments of the present disclosure may be implemented in hardware, software, or a combination of hardware and software. Software may be stored as program instruction or the computer readable code executable on a processor on a non-transitory computer readable medium. Examples of non-transitory computer readable recording medium include magnetic storage medium (e.g., ROM, floppy disk, hard disk, etc.) and optical recording medium (e.g., CD-ROM, digital video disk (DVD), etc.). The non-transitory computer readable recording medium may also be distributed on computer systems coupled by networks, so that computer-readable codes may be stored and executed in a distributed manner. The medium may be read by a computer, stored in a memory, and executed by a processor. The various embodiments may be implemented by a computer or a portable terminal including a controller and a memory, and the memory may be an example of a non-transitory computer readable recording medium suitable for storing program(s) having instruction to implement the embodiments of the present disclosure. The present disclosure may be realized by a program having code for concretely implementing the apparatus and method described in the claims, which is stored in a machine (or computer) readable storage medium. The program may be electronically carried on any medium, such as a communication signal transmitted via a wired or wireless connection, and the present disclosure suitably includes equivalents thereof.

The above description is only the specific implementation of this disclosure, but the protection scope of this disclosure is not limited to this. Any person familiar with this technical field may make various changes or substitutions within the technical scope disclosed in this disclosure, and these changes or substitutions should be covered within the protection scope of this disclosure. Therefore, the protection scope of this disclosure shall be defined by the protection scope of the claims.

The embodiment of the invention also discloses that:

(1) A method for link failure reporting performed by a user equipment, the method comprises:

transmitting a first information to a first base station, wherein the first information is used for informing the base station of information related to link failure reporting.

(2) The method according to (1), wherein,

receiving a first information request message transmitted by the first base station, wherein the first information request message is used for requesting the information related to link failure reporting.

(3) The method according to (2), wherein the first information request message includes at least one of the following information:

indication information for requesting for reporting link failure related information, wherein the link failure related information includes at least one of first link failure information, second link failure information or information of the time length;

indication information for requesting for reporting source link failure related information;

indication information for requesting for reporting target link failure related information;

indication information for requesting for reporting handover failure related information.

(4) The method according to (1), wherein the first information includes at least one of the following information:

link failure related information, wherein the link failure related information includes at least one of first link failure information, second link failure information, or information of the time length;

the first link failure information or the second link failure information;

identification information of a re-established cell;

information of the time length elapsed after the link failure;

information of the time length elapsed for successful access to a network;

indication information indicating a type of the link failure;

information of the time length elapsed from a source link failure to the successful access to a target cell by the user equipment;

information of the time length elapsed from the source link failure to a target link failure;

information of the time length elapsed from the source link failure to a handover failure;

information of the time length elapsed from the successful access to the target cell by the user equipment to the source link failure;

information of the time length elapsed from the target link failure to the source link failure;

information of the time length elapsed from the handover failure to the source link failure;

a time interval between the source link failure and the target link failure;

information of the time length on communication interruption of the user equipment;

information of the time length elapsed from initialization of a handover to successful access to the target cell;

information of the time length elapsed from the initialization of the handover to occurrence of the source link failure;

indication information indicating that the source link failure occurs before the successful access to the target cell by the user equipment;

indication information indicating that the source link failure occurs after the successful access to the target cell by the user equipment.

(5) The method according to (1), wherein the first information includes at least one of the following information:

source link failure related information;

indication information indicating that a type of a link failure is a source link failure during a handover;

indication information indicating that a cell with a link failure is a source cell during the handover;

identification information of a cell where the user equipment is located when the link failure occurs;

information of the time length elapsed from the source link failure to successful access to a target cell by the user equipment;

information of the time length elapsed from initialization of the handover to the successful access to the target cell;

information of the time length elapsed from the initialization of the handover to the source link failure.

(6) The method according to (1), further comprises:

receiving first configuration information transmitted by the first base station, wherein the first configuration information is used for the user equipment to determine whether to record the information related to link failure reporting;

determining whether to record the information related to link failure reporting according to the first configuration information.

(7) The method according to (6), wherein the first configuration information includes at least one of the following information:

indication information indicating whether to record link failure related information;

indication information indicating whether to record source link failure related information during a handover;

time threshold information indicating whether to record the link failure related information.

(8) The method according to (6), further comprises:

determining whether to record the information related to link failure reporting according to default configuration.

(9) The method according to (6), wherein the default configuration is configured based on time when the source link failure occurs or information of the time length.

(10) The method according to (6), further comprises:

detecting a link failure;

recording information related to link failure reporting.

(11) The method according to (10), wherein the recording information related to link failure reporting comprises: recording link failure related information, wherein the link failure related information includes at least one of first link failure information, second link failure information, or information of the time length.

(12) The method according to (11), wherein the first link failure or the second link failure includes a source link failure, a target link failure, or a handover failure.

(13) the method according to (11), wherein the first link failure information includes at least one of the following:

measurement information of a cell obtained by the user equipment when a first link failure occurs;

first identification information of the user equipment;

identification information of a cell where the user equipment is located when a handover command is received before the first link failure;

indication information of a cell where the user equipment is located when the first link failure occurs;

identification information of the cell where the user equipment is located when the first link failure occurs;

indication information of occurrence time of the first link failure;

indication information of a type of the first link failure;

cause information of the first link failure;

identification information of a target cell of a handover;

indication information of a type of the handover.

(14) The method according to (11), wherein the information of the time length includes at least one of the following:

information of the time length elapsed from handover initialization to occurrence of a first link failure;

information of the time length elapsed from the handover initialization to occurrence of a second link failure;

information of the time length between the occurrence of the first link failure and the occurrence of the second link failure;

information of the time length elapsed from successful access to a target cell of a handover to the occurrence of the first link failure;

information of the time length elapsed from the successful access to the target cell of the handover to the occurrence of the second link failure;

information of the time length elapsed from the occurrence of the first link failure to successful access to one cell;

information of the time length elapsed from the occurrence of the second link failure to successful access to one cell;

information of the time length elapsed from receiving a handover command to successful access to the target cell of the handover;

information of the time length for interrupting communication with a source cell of the handover.

(15) A method for link failure reporting performed by a first base station, further comprises:

receiving first information transmitted by a user equipment, wherein the first information includes information related to link failure reporting.

(16) The method according to (15), further comprises:

transmitting a first information request message to the user equipment, wherein the first information request message is used for requesting for the information related to link failure reporting.

(17) The method according to (16), wherein the first information request message includes at least one of the following information:

indication information for requesting for reporting link failure related information, wherein the link failure related information includes at least one of first link failure information, second link failure information or information of the time length;

indication information for requesting for reporting source link failure related information;

indication information for requesting for reporting target link failure related information;

indication information for requesting for reporting handover failure related information.

(18) The method according to (15), wherein the first information includes at least one of the following information:

link failure related information, wherein the link failure related information includes at least one of first link failure information, second link failure information, or information of the time length;

the first link failure information or the second link failure information;

identification information of a re-established cell;

information of the time length elapsed after the link failure;

information of the time length elapsed for successful access to a network;

indication information indicating a type of the link failure;

information of the time length elapsed from a source link failure to the successful access to a target cell by the user equipment;

information of the time length elapsed from the source link failure to a target link failure;

information of the time length elapsed from the source link failure to a handover failure;

information of the time length elapsed from the successful access of the user equipment to the target cell to the source link failure;

information of the time length elapsed from the target link failure to the source link failure;

information of the time length elapsed from the handover failure to the source link failure;

a time interval between the source link failure and the target link failure;

information of the time length on communication interruption of the user equipment;

information of the time length elapsed from initialization of a handover to successful access to the target cell;

information of the time length elapsed from the initialization of the handover to occurrence of the source link failure;

indication information indicating that the source link failure occurs before the successful access to the target cell by the user equipment;

indication information indicating that the source link failure occurs after the successful access of the user equipment to the target cell.

(19) The method according to (15), wherein the first information includes at least one of the following information:

source link failure related information;

indication information indicating that a type of a link failure is a source link failure during a handover;

indication information indicating that a cell with a link failure is a source cell during the handover;

identification information of a cell where the user equipment is located when the link failure occurs;

information of the time length elapsed from the source link failure to successful access to a target cell by the user equipment;

information of the time length elapsed from initialization of the handover to the successful access to the target cell;

information of the time length elapsed from the initialization of the handover to the source link failure.

(20) The method according to (15), further comprises:

receiving a first link failure report message transmitted by the user equipment, wherein the first link failure report message is used for informing the base station whether the user equipment stores the information related to link failure reporting;

determining whether to request the information related to link failure report from the user equipment based on the first link failure report message.

(21) the method according to (19), wherein the first link failure report message includes at least one of the following information:

indication information indicating whether to store link failure related information;

indication information indicating whether to store the source link failure related information.

(22) The method according to (15), further comprises:

receiving first user information reporting message transmitted by the user equipment, wherein the first user information reporting message includes source link failure related information, wherein the source link failure related information includes at least one of first link failure information, second link failure information or information of the time length;

transmitting a first user information forwarding message to a second base station, wherein the first user information forwarding message is used for the first base station to inform the second base station of source link failure related information.

(23) The method according to (22), wherein the first user information reporting message includes at least one of the following information:

indication information of occurrence of a source link failure;

link failure related information;

indication information of occurrence timing of the source link failure;

information of the time length elapsed from the source link failure to successful access to a target cell by the user equipment;

information of the time length elapsed from handover initialization to the successful access to the target cell;

information of the time length elapsed from the handover initialization to the source link failure;

information of the time length on communication interruption time of the user equipment.

(24) The method according to (22), wherein the first user information forwarding message includes at least one of the following information:

indication information for releasing the source link;

indication information of occurrence of a source link failure;

link failure related information;

indication information of occurrence timing of the source link failure;

information of the time length elapsed from the source link failure to successful access to a target cell by the user equipment;

information of the time length elapsed from handover initialization to the successful access to the target cell;

information of the time length elapsed from the handover initialization to the source link failure;

information of the time length on communication interruption time of the user equipment.

(25) The method according to (15), further comprises:

transmitting a first failure indication message to a second base station, wherein the first failure indication message is used for the first base station to inform the second base station of the information related to link failure of the user equipment or information related to re-establishment.

(26) The method according to (25), wherein the first failure indication message includes at least one of the following information:

link failure related information;

source link failure related information;

target link failure related information;

handover failure related information;

indication information indicating that a type of a link failure is a source link failure during a handover;

indication information indicating that a cell with a link failure is a source cell during the handover;

indication information indicating occurrence timing of the source link failure;

indication information of a cell where the user equipment is located when the link failure occurs;

information of the time length elapsed from the source link failure to successful access to the target cell by the user equipment;

information of the time length elapsed from initialization of handover to the successful access to the target cell;

information of the time length elapsed from the initialization of handover to the source link failure.

(27) The method according to (15), further comprises:

configuring network parameters according to the first information.

(28) The method according to (15), further comprises:

transmitting the first information to another base station to enable the other base station to configure network parameters.

(29) A forwarding method for link failure information performed by a second base station, the method comprises:

receiving a first failure indication message transmitted by a first base station, wherein the first failure indication message is used for the first base station to inform the second base station of information related to link failure reporting of a user equipment or information related to reestablishment;

transmitting a first handover report message to a third base station, wherein the first handover report is used for the second base station to inform the third base station of the information related to link failure reporting of the user equipment or the information related to reestablishment.

(30) The method according to (29), wherein the first failure indication message includes at least one of the following information:

link failure related information;

source link failure related information;

target link failure related information;

handover failure related information;

indication information indicating that a type of a link failure is a source link failure during a handover;

indication information indicating that a cell with the link failure is a source cell during the handover;

indication information indicating occurrence timing of the source link failure;

indication information of a cell where the user equipment is located when the link failure occurs;

information of the time length elapsed from the source link failure to successful access to the target cell by the user equipment;

information of the time length elapsed from initialization of handover to the successful access to the target cell;

information of the time length elapsed from the initialization of handover to the source link failure.

(31) The method according to (29), wherein the first handover report message includes at least one of the following information:

indication information of a type of a link failure;

indication information indicating occurrence of a source link failure;

link failure related information;

source link failure related information;

target link failure related information;

handover failure related information;

information related to mobility;

indication information indicating that the type of the link failure is the source link failure during a handover;

indication information indicating that a cell with link failure is a source cell during the handover;

indication information indicating occurrence timing of the source link failure;

identification information of a cell where the user equipment is located when the link failure occurs;

information of the time length elapsed from the source link failure to the successful access to a target cell by the user equipment;

information of the time length elapsed from initialization of the handover to the successful access to the target cell;

information of the time length elapsed from the initialization of the handover to the source link failure.

(32) A method for recording link failure related information performed by a user equipment, the method comprises:

detecting a link failure;

recording link failure related information, wherein the link failure related information includes at least one of first link failure information, second link failure information, or information of the time length.

(33) The method according to (32), wherein the first link failure or the second link failure includes a source link failure, a target link failure, or a handover failure.

(34) the method according to (32), wherein the first link failure information includes at least one of the following:

measurement information of a cell obtained by the user equipment when a first link failure occurs;

first identification information of the user equipment;

identification information of a cell where the user equipment is located when a handover command is received before the first link failure;

indication information of a cell where the user equipment is located when the first link failure occurs;

identification information of the cell where the user equipment is located when the first link failure occurs;

indication information of occurrence time of the first link failure;

indication information of a type of the first link failure;

cause information of the first link failure;

identification information of a target cell of a handover;

indication information of a type of the handover.

(35) The method according to (32), wherein the information of the time length includes at least one of the following:

information of the time length elapsed from handover initialization to occurrence of a first link failure;

information of the time length elapsed from the handover initialization to occurrence of a second link failure;

information of the time length between the occurrence of the first link failure and the occurrence of the second link failure;

information of the time length elapsed from successful access to a target cell of a handover to the occurrence of the first link failure;

information of the time length elapsed from the successful access to the target cell of the handover to the occurrence of the second link failure;

information of the time length elapsed from the occurrence of the first link failure to successful access to one cell;

information of the time length elapsed from the occurrence of the second link failure to successful access to one cell;

information of the time length elapsed from receiving a handover command to successful access to the target cell of the handover;

information of the time length for interrupting communication with a source cell of the handover.

(36) A configuration method of link failure performed by a user equipment, further comprises:

receiving a first configuration information transmitted by a first base station, wherein the first configuration information is used for the user equipment to determine whether to record information related to link failure reporting;

determining whether to record the information related to link failure reporting according to the first configuration information.

(37) The method according to (36), wherein the first configuration information includes at least one of the following information:

indication information indicating whether to record link failure related information;

indication information indicating whether to record source link failure related information during a handover;

time threshold information indicating whether to record the link failure related information.

(38) The method according to (36), further comprises:

determining whether to record the information related to link failure reporting according to default configuration.

(39) The method according to (38), wherein the default configuration is configured based on time when the source link failure occurs or information of the time length

(40) The method according to (36), further comprises:

detecting a link failure;

recording the information related to link failure reporting.

(41) The method according to (40), wherein the recording the information related to link failure reporting comprises at least one of recording link failure related information and recording source link failure related information during a handover.

(42) The method according to (41), wherein the link failure related information includes at least one of first link failure information, second link failure information, or information of the time length.

(43) the method according to (42), wherein the first link failure information includes at least one of the following:

measurement information of a cell obtained by the user equipment when a first link failure occurs;

first identification information of the user equipment;

identification information of a cell where the user equipment is located when a handover command is received before the first link failure;

indication information of a cell where the user equipment is located when the first link failure occurs;

identification information of the cell where the user equipment is located when the first link failure occurs;

indication information of occurrence time of the first link failure;

indication information of a type of the first link failure;

cause information of the first link failure;

identification information of a target cell of the handover;

indication information of a type of the handover.

(44) The method according to (42), wherein the information of the time length includes at least one of the following:

information of the time length elapsed from handover initialization to occurrence of a first link failure;

information of the time length elapsed from the handover initialization to occurrence of a second link failure;

information of the time length between the occurrence of the first link failure and the occurrence of the second link failure;

information of the time length elapsed from successful access to a target cell of a handover to the occurrence of the first link failure;

information of the time length elapsed from the successful access to the target cell of the handover to the occurrence of the second link failure;

information of the time length elapsed from the occurrence of the first link failure to successful access to one cell;

information of the time length elapsed from the occurrence of the second link failure to successful access to one cell;

information of the time length elapsed from receiving a handover command to successful access to the target cell of the handover;

information of the time length for interrupting communication with a source cell of the handover.

(45) A method for link failure reporting performed by a first base station, the method comprises:

receiving a first link failure report message transmitted by a user equipment, wherein the first link failure report message is used for informing the base station whether the user equipment stores information related to link failure reporting;

determining whether to request for the information related to link failure report from the user equipment based on the first link failure report message.

(46) the method according to (45), wherein the first link failure report message includes at least one of the following information:

indication information indicating whether to store link failure related information;

indication information indicating whether to store source link failure related information.

(47) A user equipment, the user equipment comprises:

a transceiver configured to transmit and receive signals with outside; and

a processor configured to control the transceiver to execute the method according to any one of (1)-(14) or (32)-(44).

(48) A base station, the user equipment comprises:

a transceiver configured to transmit and receive signals with outside; and

a processor configured to control the transceiver to execute the method according to any one of (15)-(31) or (43)-(46).

(49) A non-transitory computer-readable recording medium having stored thereon a program, which when executed by a computer, performs the method according to any one of (1) to (46).

1-15. (canceled)

16. A method performed by a user equipment (UE) in a wireless communication system, the method comprising:
receiving, from a base station (BS), a first reconfiguration message related to a handover including time threshold information;
in case that a length of time obtained by the UE is greater than the time threshold information, storing information related to the handover; and
transmitting, to the BS, a report message including the information related to the handover.

17. The method of claim 16, wherein the first reconfiguration message includes information indicating whether the UE stores the information related to the handover in case that a radio link failure occurs in a source cell during the handover.

18. The method of claim 16, wherein the information related to the handover includes at least one of:
measurement information of a cell of the UE,
identification information of the UE,
identification information of a source cell,
identification information of a target cell, or
indication information of a type of the radio link failure.

19. The method of claim 16, wherein the information related to the handover includes measurement information of a cell of the UE, and
wherein the measurement information of the cell of the UE includes at least one of:
reference signal receiving power (RSRP) of the source cell or the target cell,
reference signal receiving quality (RSRQ) of the source cell or the target cell, and
signal to interference noise ratio (SINR) of the source cell or the target cell.

20. The method of claim 18, wherein the identification information of the UE includes a cell-radio network temporary identifier (C-RNTI) of the UE in the target cell, and
wherein the indication information of a type of the radio link failure indicates whether a radio link failure occurs in the source cell.

21. The method of claim 16, further comprising:
detecting a link failure; and
transmitting, to the BS, a report message related to the link failure.

22. The method of claim 16, wherein the first reconfiguration message includes at least one of:
identification information of a reestablished cell,
indication information indicating a type of a link failure,
indication information indicating that a source link failure occurs before a successful access of the UE to the target cell, and
indication information indicating that the source link failure occurs after the successful access of the UE to the target cell.

23. A method performed by a base station (BS), the method comprising:
transmitting, to a user equipment (UE), first reconfiguration message related to a handover including time threshold information; and
receiving, from the UE, a report message including information related to the handover.

24. The method of claim 23, wherein the first reconfiguration message includes information indicating whether the UE stores the information related to the handover in case that a radio link failure occurs in a source cell during the handover.

25. The method of claim 23, wherein the information related to the handover includes at least one of:
measurement information of a cell of the UE,
identification information of the UE,
identification information of a source cell,
identification information of a target cell, or
indication information of a type of the radio link failure.

26. The method of claim 23, wherein the information related to the handover includes measurement information of a cell of the UE, and
wherein the measurement information of the cell of the UE includes at least one of:
reference signal receiving power (RSRP) of the source cell or the target cell,
reference signal receiving quality (RSRQ) of the source cell or the target cell, and
signal to interference noise ratio (SINR) of the source cell or the target cell.

27. The method of claim 25, wherein the identification information of the UE includes a cell-radio network temporary identifier (C-RNTI) of the UE in the target cell,
wherein the indication information of a type of the radio link failure indicates whether a radio link failure occurs in the source cell.

28. The method of claim 23, wherein the first reconfiguration message includes at least one of:
identification information of a reestablished cell,
indication information indicating a type of a link failure,
indication information indicating that a source link failure occurs before a successful access of the UE to the target cell, and
indication information indicating that the source link failure occurs after the successful access of the UE to the target cell.

29. A user equipment (UE) in a wireless communication system, the UE comprising:
a transceiver; and
a processor coupled to the transceiver, wherein the processor is configured to:
receive, from a base station (BS), a first reconfiguration message related to a handover including time threshold information;
in case that a length of time obtained by the UE is greater than the time threshold information, store information related to the handover; and
transmit, to the BS, a report message including the information related to the handover.

30. The UE of claim 29, wherein the first reconfiguration message includes information indicating whether the UE stores the information related to the handover in case that a radio link failure occurs in a source cell during the handover.

31. The UE of claim 29, wherein the information related to the handover includes at least one of:
measurement information of a cell of the UE,
identification information of the UE,
identification information of a source cell,
identification information of a target cell, or
indication information of a type of the radio link failure.

32. The UE of claim 31, wherein the measurement information of the cell of the UE includes at least one of:
reference signal receiving power (RSRP) of the source cell or the target cell,
reference signal receiving quality (RSRQ) of the source cell or the target cell, and
signal to interference noise ratio (SINR) of the source cell or the target cell,
wherein the identification information of the UE includes a cell-radio network temporary identifier (C-RNTI) of the UE in the target cell,
wherein the indication information of a type of the radio link failure indicates whether a radio link failure occurs in the source cell,
wherein indication information indicating that a source link failure occurs before a successful access of the UE to the target cell, and
wherein indication information indicating that the source link failure occurs after the successful access of the UE to the target cell.

33. A base station (BS) in a wireless communication system, the BS comprising:
a transceiver; and
a processor coupled to the transceiver, wherein the processor is configured to:
transmit, to a user equipment (UE), a first reconfiguration message related to a handover including time threshold information, and
receive, from the UE, a report message including information related to the handover.

34. The BS of claim 33, wherein the first reconfiguration message includes information indicating whether the UE stores the information related to the handover in case that a radio link failure occurs in a source cell during the handover.

35. The BS of claim 33, wherein the information related to the handover includes at least one of:
measurement information of a cell of the UE,
identification information of the UE,
identification information of a source cell,
identification information of a target cell, or
indication information of a type of the radio link failure.
